(19) United States
(12) Patent Application Publication
(10) Pub. No.: US 2025/0175623 A1
(43) Pub. Date: May 29, 2025

(54) METHOD AND SYSTEM FOR CONTENT-BASED SCALING FOR ARTIFICIAL INTELLIGENCE BASED INLOOP FILTERS

(71) Applicant: SAMSUNG ELECTRONICS CO., LTD., Suwon-si (KR)

(72) Inventors: Aviral AGRAWAL, Ghaziabad (IN); Anubhav SINGH, Bangalore (IN); Raj Narayana GADDE, Bangalore (IN); Yinji PIAO, Suwon-si (KR); Minwoo PARK, Suwon-si (KR); Kwangpyo CHOI, Suwon-si (KR)

(73) Assignee: SAMSUNG ELECTRONICS CO., LTD., Suwon-si (KR)

(21) Appl. No.: 19/038,278

(22) Filed: Jan. 27, 2025

Related U.S. Application Data
(63) Continuation of application No. PCT/KR2023/010658, filed on Jul. 24, 2023.

(30) Foreign Application Priority Data
Jul. 27, 2022 (IN) 202241042992
Jun. 9, 2023 (IN) 202241042992

(51) Int. Cl. H04N 19/172; H04N 19/117; H04N 19/119; H04N 19/59; H04N 19/80

(52) U.S. Cl. CPC H04N 19/172; H04N 19/117; H04N 19/119; H04N 19/59; H04N 19/80

(57) ABSTRACT

A method, performed by an electronic device, for artificial intelligence (AI)-based encoding of media includes compressing an input image frame associated with an input video, generating, by an AI-based in-loop filter, a reconstructed image frame corresponding to the input image frame, determining an offset value based on the input image frame and the reconstructed image frame, and encoding the reconstructed image frame based on the offset value.

### CROSS-REFERENCE TO RELATED APPLICATIONS

This application is a continuation application of International Application No. PCT/KR2023/010658, filed on Jul. 24, 2023, which claims priority to Indian Patent Application number 202241042992 filed on Jun. 9, 2023, and to Indian Provisional Patent Application No. 202241042992, filed on Jul. 27, 2022, in the Indian Patent Office, the disclosures of which are incorporated by reference herein in their entireties.

### BACKGROUND

### 1. Field

The present disclosure relates generally to image processing, and more particularly, to a method and a system for content-based scaling for artificial intelligence (AI)-based in-loop filters.

### 2. Description of Related Art

Video compression techniques may be used as a basis of video content development for consumption by users. For example, video compression techniques may potentially reduce transmission times and/or bandwidth requirements by reducing a size of the video content. With the arrival of artificial intelligence (AI) technology, video codec standard bodies may attempt to obtain potential benefits by applying AI technology to the video compression techniques. However, implementation of AI-based models (such as, but not limited to, deep neural networks, linear regression, or the like) may present different sets of obstacles.

The video compression techniques may include a video codec pipeline for compression of a wide variety of content, which may include relatively newer content that may have been recently developed, such as, but not limited to, content with higher resolutions, content with different screen contents, or the like. AI-based coding tools may be introduced into the video codec pipeline by training an AI-based model and deploying the AI-based model into the video codec pipeline. However, the AI-based model may only be trained on a restricted set of training data that may have been gathered at a certain point in time. Consequently, inherent bias and/or variance may be introduced into the AI-based models, which may potentially lead to unexpected performance and/or untrustworthy results.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

According to an aspect of the present disclosure, a method, performed by an electronic device, for artificial intelligence (AI)-based encoding of media includes compressing an input image frame associated with an input video, generating, by an AI-based in-loop filter, a reconstructed image frame corresponding to the input image frame, determining an offset value based on the input image frame and the reconstructed image frame, and encoding the reconstructed image frame based on the offset value.

According to an aspect of the present disclosure, a method, performed by an electronic device, for AI-based decoding of media includes receiving, from an encoder, first bitstream information including offset information, generating, by an AI-based in-loop filter, a reconstructed image frame based on the first bitstream information, performing a scaling operation on the reconstructed image frame based on the offset information to generate a scaled image frame, and generating an output video based on the scaled image frame.

According to an aspect of the present disclosure, a system for AI-based encoding of media includes memory storing instructions, and one or more processors communicatively coupled to the memory. The one or more processors are configured to execute the instructions to compress an input image frame associated with an input video, generate, by an AI-based in-loop filter, a reconstructed image frame corresponding to the input image frame, determine an offset value based on the input image frame and the reconstructed image frame, and encode the reconstructed image frame based on the offset value.

According to an aspect of the present disclosure, a system for AI-based encoding of media includes memory storing instructions, and one or more processors communicatively coupled to the memory. The one or more processors are configured to execute the instructions to receive, from an encoder, first bitstream information including offset information, generate, by an AI-based in-loop filter, a reconstructed image frame based on the first bitstream information, perform a scaling operation on the reconstructed image frame based on the offset information to generate a scaled image frame, and generate an output video based on the scaled image frame.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1A illustrates an example scenario for visualizing a tradeoff between a bias and a variance in an artificial intelligence (AI) based model, according to an embodiment of the disclosure;

FIG. 1B illustrates a limitation of the AI-based model based on learned bias and variance from training data, according to an embodiment of the disclosure;

FIG. 2A illustrates a block diagram of a related versatile video coding (VVC) decoder, according to an embodiment of the disclosure;

FIG. 2B illustrates a related VVC decoder pipeline with an AI-based in-loop filter, according to an embodiment of the disclosure;

FIG. 3 illustrates a block diagram of a VVC encoder pipeline for an AI-based encoding of media, according to an embodiment of the disclosure;

FIG. 4 illustrates a rate distortion plot to determine a rate distortion (RD) cost value for each compressed image frame for the AI-based encoding of the media, according to an embodiment of the disclosure;

FIG. 5 illustrates an exemplary architecture of a deep convolutional neural network (DCNN) associated with an AI-based in-loop filter to potentially enhance the quality of each compressed image frame for the AI-based encoding of the media, according to an embodiment of the disclosure;

FIG. 6 illustrates an exemplary scenario to generate a set of first representative data points, according to an embodiment of the disclosure;

FIG. 7 illustrates an exemplary scenario to generate a set of second representative data points, according to an embodiment of the disclosure;

FIG. 8 illustrates an exemplary scenario for generating a pixel mapping for an offset scaling for the AI-based encoding of the media, according to an embodiment of the disclosure;

FIG. 9 illustrates an exemplary scenario for generating the offset scaling, according to an embodiment of the disclosure;

FIGS. 10 and 11 illustrate multiple ways of modeling domain, according to an embodiment of the disclosure;

FIG. 12 illustrates a block diagram of a VVC decoder pipeline for the AI-based encoding of the media, according to an embodiment of the disclosure;

FIG. 13A illustrates a block diagram of an electronic device for the AI-based encoding of the media, according to an embodiment of the disclosure;

FIG. 13B illustrates a block diagram of an electronic device for the AI-based decoding of the media, according to an embodiment of the disclosure;

FIG. 14 is a flow diagram illustrating a method for the AI-based encoding of media, according to an embodiment of the disclosure;

FIG. 15 is a flow diagram illustrating a method for the AI-based compressing of the media, according to an embodiment of the disclosure; and

FIG. 16 is a flow diagram illustrating a method for the AI-based decoding of the media, according to an embodiment of the disclosure.

### DETAILED DESCRIPTION

For the purpose of promoting an understanding of the principles of the present disclosure, reference may be made to the embodiments illustrated in the drawings and specific language may be used to describe the same. It is to be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It is to be understood by those skilled in the art that the foregoing general description and the following detailed description are explanatory of the present disclosure and are not intended to be restrictive thereof.

Reference throughout this present disclosure to “an aspect”, “another aspect” or similar language may indicate that a particular feature, structure, or characteristic described in connection with the embodiment may be included in at least one embodiment of the present disclosure. Thus, appearances of the phrases “in an embodiment”, “in one embodiment”, “in another embodiment”, and similar language throughout the present disclosure may, but not necessarily, all refer to the same embodiment.

The terms “comprise”, “comprising”, or any other variations thereof, may be intended to cover a non-exclusive inclusion, such that a process or method that comprises a list of operations may not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Throughout the disclosure, the expression “at least one of a, b or c” may indicate only a, only b, only c, both a and b, both a and c, both b and c, all of a, b, and c, or variations thereof.

The embodiments herein and the various features and advantageous details thereof may be explained more fully with reference to the non-limiting embodiments that are illustrated in the accompanying drawings and detailed in the following description. Descriptions of well-known components and processing techniques may be omitted so as to not unnecessarily obscure the embodiments herein. In addition, the various embodiments described herein may not necessarily be mutually exclusive, as some embodiments may be combined with one or more other embodiments to form new embodiments. The term “or” as used herein, may refer to a non-exclusive or unless otherwise indicated. The examples used herein may merely be intended to facilitate an understanding of ways in which the embodiments herein may be practiced and to further enable those skilled in the art to practice the embodiments herein. Accordingly, the examples should not be construed as limiting the scope of the embodiments herein.

With regard to the description of the drawings, similar reference numerals may be used to refer to similar or related elements.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

One or more example embodiments of the present disclosure may be described and/or illustrated in terms of blocks that may carry out a described function or functions. These blocks, which may be referred to herein as units or modules or the like, may be physically implemented by analog or digital circuits such as, but not limited to, logic gates, integrated circuits, microprocessors, microcontrollers, memory circuits, passive electronic components, active electronic components, optical components, hardwired circuits, or the like, and may optionally be driven by firmware and/or software. The circuits may, for example, be embodied in one or more semiconductor chips, or on substrate supports such as, but not limited to, printed circuit boards (PCBs) or the like. The circuits constituting a block may be implemented by dedicated hardware, or by a processor (e.g., one or more programmed microprocessors and associated circuitry), or by a combination of dedicated hardware configured to perform some functions of the block and a processor to perform other functions of the block. Each block of the embodiments may be physically separated into two or more interacting and discrete blocks without departing from the scope of the invention. Similarly, the blocks of the embodiments may be physically combined into more complex blocks without departing from the scope of the present disclosure.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

The accompanying drawings may be used to help understand various technical features. It is to be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, or the like may be used herein to describe various elements, these elements should not be limited by these terms. These terms may generally only be used to distinguish one element from another.

Throughout the present disclosure, the terms “desired compression level” and “desired level of compression” may be used interchangeably and refer to the same. Throughout the present disclosure, the terms “input video”, “input video data”, and “input media” may be used interchangeably and refer to the same. The terms “reconstructed video”, “output video”, and “optimized compressed media” may be used interchangeably and refer to the same.

Bias and variance may be considered as key properties of a model (e.g., artificial intelligence (AI)-based model, machine learning (ML) model, or the like). The bias of a model may refer to how well the model may represent all potential outcomes. Alternatively or additionally, the variance of a model may refer to how much the predictions of the model may be influenced by small changes in an input data. A tradeoff between the bias and variance may be considered to be a basic problem in the model, and the tradeoff may be needed to experiment with several model types in order to find a balance that may be optimized for the training data.

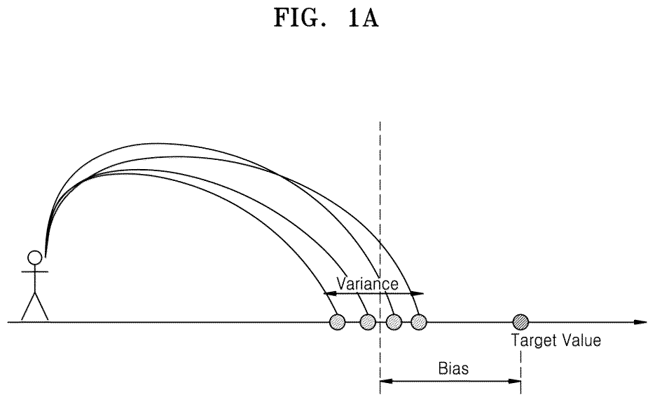

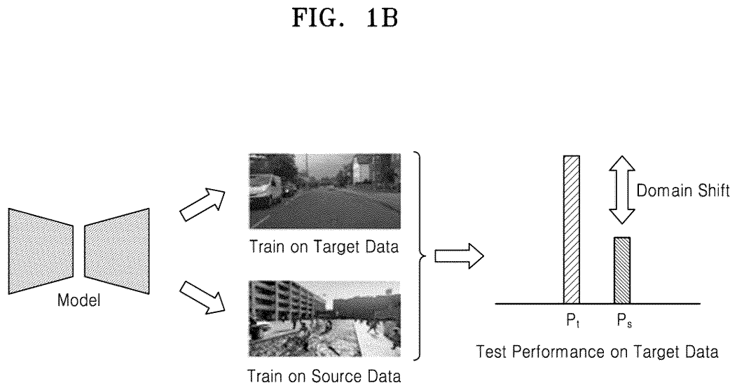

FIG. 1A illustrates an example scenario for visualizing the tradeoff between the bias and the variance in the AI-based model, according to an embodiment of the disclosure. As shown in FIG. 1A, a person may throw one or more stones in in an attempt to reach a point that may signify a target value. The one or more stones may, however, strike on a ground at various positions that may be far from the target value. In such an example, the bias may be depicted as a gap between the target value (e.g., actual value) and an average of the spots where the one or more stones landed. The dashed line may reflect an average of predictions provided by one or more AI-based models, different positions where the one or more stones strike on the ground, trained using different training data sets drawn from a same population. That is, the dashed line may reflect an expected position where the one or more stones may be struck on the ground based on the calculations of the one or more AI-based models.

In a case in which each AI-based model may be trained with different training data, the one or more stones may land at various positions around the target value. The dashed line may serve as an approximation of the expected outcome based on the one or more AI-based models, taking into account the variations in the positions where the one or more stones struck on the ground. The shorter that the distance from the expected outcome to the target value is, the smaller that the bias between the average (e.g., dashed line) and the target value may be, thereby resulting in a potentially better model. The variance may be represented as a spread of the individual points around the average (e.g., dashed line). The lower spread and variance may be indicative of a superior (or preferred) model from among the one or more AI-based models. That is, the lower spread may imply a higher level of accuracy and precision in the predictions of the model. By minimizing the variance, the model may be able to predict outcomes and provide more reliable results accurately, when compared to the remaining AI-based models.

FIG. 1B illustrates a limitation of the AI-based model based on learned bias and variance from the training data, according to an embodiment of the disclosure. To obtain a desired performance and trustworthy answers (e.g., results with a relatively high confidence level) from the AI-based model, source data (e.g., training data) and target data (e.g., test data) may need to be from the same sample space. However, in a real-time environment, the source data and the target data may belong to different sample spaces. In such a case, the AI-based model may be unable to provide the expected performance and trustworthy responses. For example, in a scenario where the AI-based model may be trained solely on faces of a single ethnic background (e.g., limited training data) for face classification and detection, the trained AI-based model may not perform as expected if the trained AI-based model is provided with faces of another ethnic background (e.g., newer and/or unseen data). That is, differences between the training data and the test data (e.g., anchor point changes in the faces) may invalidate the initial training of the AI-based model. For example, the trained AI-based model may have learned bias and variance for the faces of the first ethnic background, and as such, may be unable to provide an expected performance and/or trustworthy responses from the faces of the second ethnic background. To address this issue, the AI-based model may need to be re-trained whenever a new sample space is found, which may lead to extensive and continuous manual training efforts.

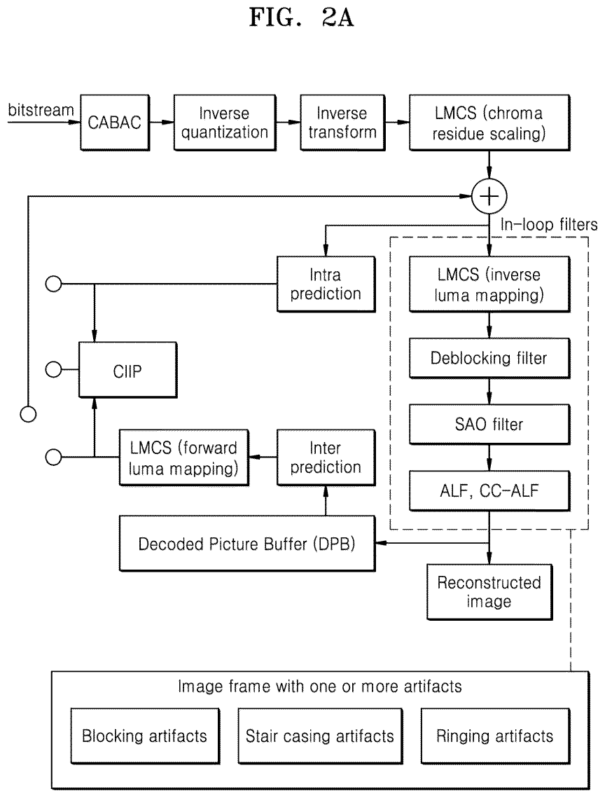

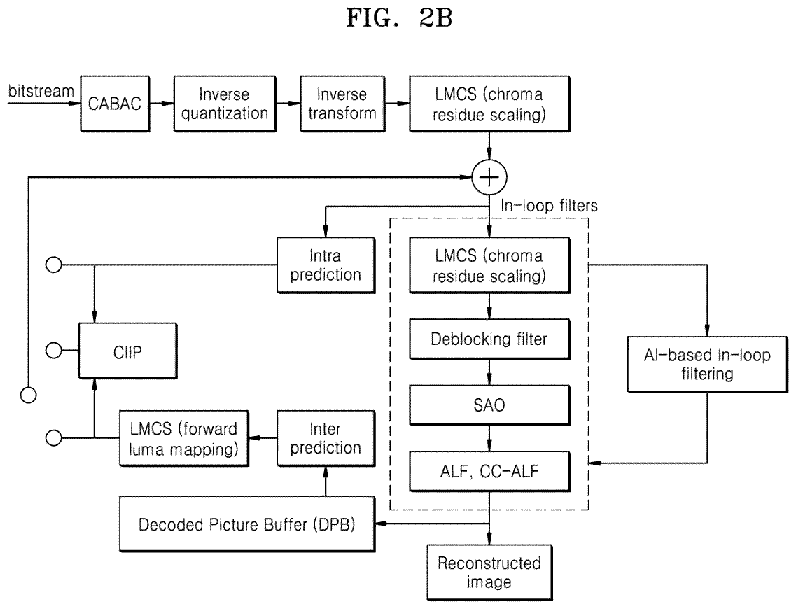

Further, the AI-based model may get stale over time owing to the ongoing generation of newer forms of data, and as a result, may need to be re-trained. Re-training the AI-based model on a regular basis may be inconvenient. The video compression technique, for example, may be deployed globally, and frequent adjustments in the weights of the AI-based model may not be desirable. Furthermore, related in-loop filters (ILFs) connected with the AI-based model may utilize image and/or signal processing principles to identify a certain type of artifact. With limited options, the related ILFs may employ numerous modes/filters to best suit for the given content, as shown in FIGS. 2A and 2B, and as discussed in the present disclosure. Experimenting with various modes/filters for a single input may increase an encoding time. In addition, some related ILFs may not use measurements as a measure of quality, and instead may focus on visible artifacts, which may make such ILFs rigid.

FIG. 2A illustrates a block diagram of a related versatile video coding (VVC) decoder, according to an embodiment of the disclosure. The VVC decoder may be a part of video coding systems that may enable compression and decompression of video data. The VVC decoder may be configured to provide video playback while minimizing an amount of data that may be needed for transmission and/or storage. The VVC decoder may include a context-adaptive binary arithmetic coding (CABAC), which may be configured to perform an entropy coding technique that may adapt to the statistical properties of input data. The CABAC may allow the VVC decoder to achieve relatively high compression ratios without significantly decreasing video quality. In addition to the CABAC, the VVC decoder may include other modules such as, but not limited to, an inverse quantization module, an inverse transform module, a luma mapping with chroma scaling (LMCS) module, an in-loop filter module, an intra prediction module, an inter prediction module, a forward luma mapping LMCS module, a combined inter intra prediction (CIIP) module, a decoded picture buffer (DPB) module, a reconstructed image module, or the like. The inverse quantization and inverse transform modules may be configured to convert the quantized and transformed video data back into its original form. The LMCS module may be configured to adjust chroma and/or luma components of the video data to potentially improve overall image quality.

Additionally, the in-loop filters may be configured to remove artifacts and/or noise that may occur during a video compression process. For example, the in-loop filters may include an inverse LMCS filter, a deblocking filter (DBF), a sample adaptive offset (SAO) filter, an adaptive loop filter (ALF), a cross-component adaptive loop filtering (CC-ALF), or the like. The inverse LMCS filter may be configured to adjust chroma scaling to match luma mapping and to ensure proper color representation in the video compression process. The DBF filter may be used on block borders to potentially eliminate blocking artifacts. The SAO filter may be subsequently applied to deblocked samples. The SAO filter may be configured to remove ringing artifacts and/or to correct for local average intensity shifts. The ALF and CC-ALF may perform block-based linear filtering and adaptive filtering to minimize a mean squared error (MSE) between original data (e.g., original image) and recreated data (e.g., reconstructed image).

The DPB and the reconstructed image modules may work in conjunction to store and/or display decoded video data. For example, the DPB module may store previously decoded frames to enable inter-frame prediction, and the reconstructed image module may generate a high-quality display image from the decoded video data.

The intra and inter-prediction modules may be configured to predict the values of the video data based on spatial and temporal correlations. The predicted values may be used to potentially reduce the amount of data that may need to be transmitted and/or stored by only encoding the differences between the predicted and the actual values. The CIIP module may combine both intra and inter-prediction techniques to potentially further improve compression efficiency.

In the related VVC decoder, each in-loop filter may target a distinct artifact and/or a pre-defined artifact. For example, the DBF may only target the blocking artifacts. As a result, the filtering process may be unable to adjust performance based on a type of input content since there is no intelligent element present in the filtering process. To get the best performance, the filtering process uses heuristics to select among a number of different filter versions (e.g., LMCS, DBF, SAO, or the like), which degrades the user experience.

FIG. 2B illustrates a related VVC decoder pipeline with an AI-based in-loop filter, according to an embodiment of the disclosure.

The related VVC decoder pipeline with the AI-based in-loop filter of FIG. 2B may include and/or may be similar in many respects to the related VVC decoder pipeline described above with reference to FIG. 2A, and may include additional features not mentioned above. Consequently, repeated descriptions of the related VVC decoder pipeline with the AI-based in-loop filter described above with reference to FIG. 2A may be omitted for the sake of brevity.

In comparison to the block diagram in FIG. 2A, the AI-based in-loop filter may be an additional component in the related VVC decoder pipeline. The AI-based in-loop filter may potentially eliminate and/or reduce one or more issues of the in-loop filters (e.g., each filter may target a distinct artifact and/or a pre-defined artifact). However, as shown in FIG. 1B, the AI-based in-loop filter may add an intrinsic bias and/or variation to the related VVC decoder pipeline in a case in which a limited quantity of training data may be used to train the AI-based model of the AI-based in-loop filter. As a result, the AI-based in-loop filter may produce unexpected results and/or generate responses with a low confidence level, in scenarios where the AI-based model has not been trained. Further, the AI-based model may get stale over time owing to an ongoing generation of newer forms of data, and as such, may need to be retrained. However, retraining the AI-based model on a regular basis may be inconvenient.

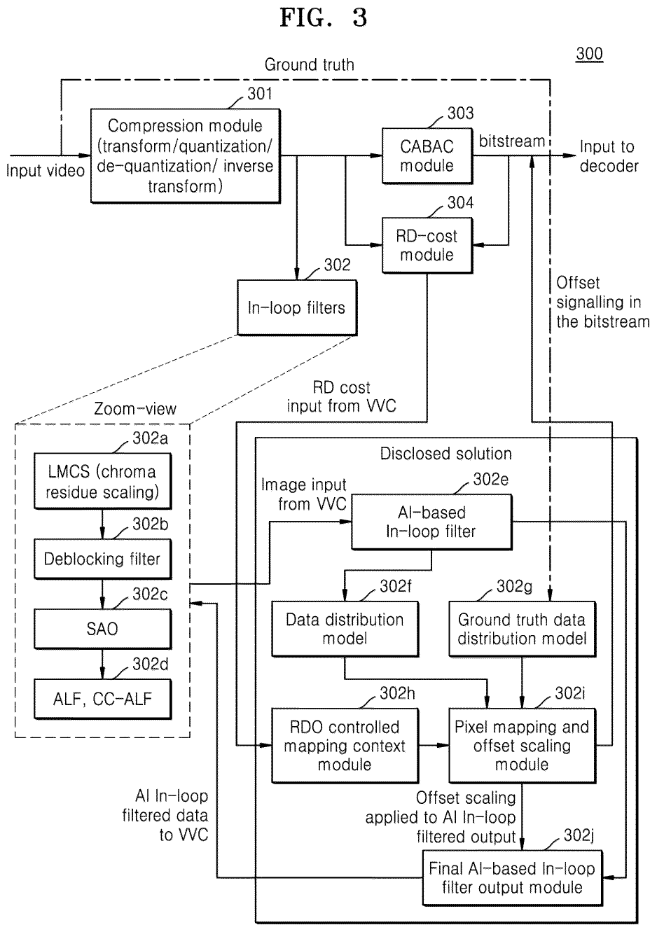

A method, according to an embodiment of the disclosure, may provide a strategy for augmenting the AI-based model with an additional real-time module that may adjust to newer and/or unseen data by performing a content-based scaling to reduce data domain gaps, as described with reference to FIGS. 3 to 16. The method, according to an embodiment of the disclosure, may use pixel mapping to bridge the data domain gaps between newer and/or unseen data and training data in AI-based in-loop filters. As a result, the method, according to an embodiment of the disclosure, may outperform related methods that may target particular artifacts and may be frequently trained using limited data, resulting in an inherent bias and/or volatility in the AI-based trained models. The method, according to an embodiment of the disclosure, may enable content-based scaling to identify the pixel mapping for scaling an offset, operate on the fly, not require pre-training, and may provide greater generalization for different types of data, when compared to related methods. Furthermore, the method, according to an embodiment of the disclosure, may have a relatively low level of complexity when compared to the related methods, as the related methods may deploy relatively complex deep neural network (DNN) models in an attempt to achieve higher gain, even though the related methods may not be adaptive in a content-to-content basis. The method, according to an embodiment of the disclosure, may address at least these issues by performing video data-based statistical regression during an encoding process and using the same during a decoding process.

Hereinafter, various embodiments of the present disclosure are described with reference to the accompanying drawings, FIGS. 3 to 16 in particular.

FIG. 3 illustrates a block diagram of a VVC encoder pipeline 300 for an AI-based encoding of media (e.g., input video), according to an embodiment of the disclosure.

The VVC encoder pipeline 300 may include and/or may be similar in many respects to the related VVC decoder pipelines described above with reference to FIGS. 2A and 2B, and may include additional features not mentioned above. Consequently, repeated descriptions of the VVC encoder pipeline 300 described above with reference to FIGS. 2A and 2B may be omitted for the sake of brevity.

The VVC encoder pipeline 300 may include a plurality of modules. The plurality of modules may include a compression module 301, in-loop filters 302, a CABAC module 303, and rate distortion (RD) cost module 304. The compression module 301 may be configured to receive (or identify) an input video (e.g., one or more input image frames). Upon receiving the input video, the compression module 301 may perform one or more pre-defined operations on the received input video such as, but not limited to, a transformation, a quantization, a de-quantization, an inverse transformation, or the like.

The transformation operation may include converting data (e.g., input video) from its original domain representation into a different domain, where the data may be more efficiently compressed. In an embodiment of the disclosure, the data may include transformed coefficients. The transformation operation may be achieved using mathematical techniques, such as, but not limited to, a discrete cosine transform (DCT), a discrete wavelet transform (DWT), or the like.

In an embodiment of the disclosure, the quantization operation may be performed subsequent to the data having been transformed. The quantization operation may include reducing a precision and/or a dynamic range of the transformed coefficients. The transformed coefficients may map a continuous range of values to a finite set of discrete levels. For example, by quantizing the transformed coefficients, information may be lost, which may contribute to the compression.

The de-quantization operation may be a reverse operation of the quantization operation. The de-quantization operation may include restoring the quantized coefficients back to their approximate original values, which may be achieved by multiplying each quantized coefficient by a de-quantization factor. The de-quantization operation may be performed during decompression to recover an approximation of the original transformed coefficients.

The inverse transform operation may include converting the transformed and de-quantized coefficients back to the original domain. The inverse transform operation may perform the reverse operation of the initial transformation, reconstructing the compressed data to closely resemble the original input (e.g., input video). The inverse transform operation, such as, but not limited to, an inverse DCT or an inverse DWT, may effectively reverse the decorrelation and concentration of energy performed during the initial transform stage.

The in-loop filters 302 may receive (or identify) the compressed data (e.g., quantized data, reconstructed data) from the compression module 301. The in-loop filters 302 may be configured to remove artifacts and/or noise that may occur during the compression operations. The in-loop filters 302 may include an LMCS 302a, a DBF 302b, an SAO filter 302c, an ALF filter 302d, and a CC-ALF filter 302d. The functionality of various filters included in the in-loop filters (e.g., filters 302a to 302d) may be substantially similar and/or the same functionality as described with reference to the in-loop filters of FIG. 2A.

In one or more embodiments of the disclosure, the in-loop filters 302 may include an AI-based in-loop filter 302e, a data distribution model 302f, a ground truth data distribution model 302g, a rate distortion optimization (RDO)-controlled mapping extent module 302h, a pixel mapping for offset scaling module 302i, and a final AI-based in-loop filter output module 302j.

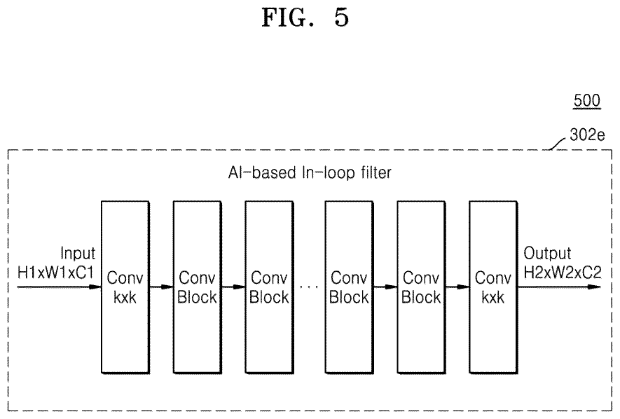

In one or more embodiments of the disclosure, the AI-based in-loop filter 302e may be configured to apply AI techniques in the loop filtering process of video coding, as described with reference to FIG. 5. The in-loop filter modules 302a to 302d may be designed using a fixed methodology to reduce compression artifacts, such as, but not limited to, blocking and/or ringing artifacts. However, recent advancements in AI and/or machine learning may be applied to the use of AI-based approaches in order to potentially enhance the performance of the in-loop filter modules 302a to 302d. For example, the AI-based in-loop filter 302e may leverage machine learning models to learn the characteristics of video content (e.g., image input from VVC, input video, or the like) and apply adaptive filtering techniques. That is, instead of relying on predefined rules or heuristics, the AI-based in-loop filter 302e may use neural networks and/or other AI methodologies to analyze and/or process the video content. The AI-based in-loop filter 302e may use AI models and may learn from relatively large amounts of training data to make comparatively intelligent decisions regarding the filtering operations, when compared to related in-loop filter modules. By using AI-based in-loop filter 302e, it may be possible to improve the effectiveness of artifact reduction, when compared to the related in-loop filter modules, particularly in challenging scenarios where the related in-loop filter modules may struggle. That is, the AI models may adapt to different content types, may handle complex textures and/or motion, and/or may preserve details in a better manner while reducing artifacts. Overall, the AI-based in-loop filter 302e may leverage capabilities of the AI to enhance the quality of encoded video content by potentially reducing compression artifacts more adaptively than the related in-loop filter modules. The encoded video content may include a reconstructed video and/or one or more reconstructed image frames, as described with reference to FIG. 5.

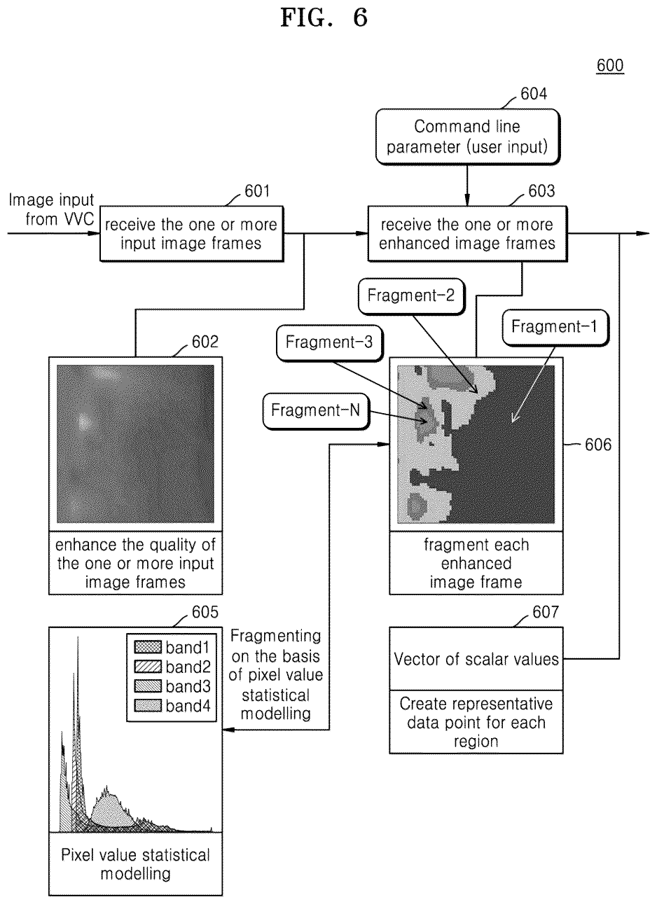

In one or more embodiments of the disclosure, the data distribution model 302f may generate a set of first representative data points, as described with reference to FIG. 6. The data distribution model 302f may execute multiple operations to generate the set of first representative data points.

The data distribution model 302f may receive (or identify) one or more reconstructed image frames (e.g., one or more enhanced image frames, model output data) from the AI-based in-loop filter 302e. The one or more reconstructed image frames may be associated with the reconstructed video. The data distribution model 302f may receive (or identify) a user input indicating a desired level of compression for each of the one or more reconstructed image frames. The data distribution model 302f may determine a number of fragments (e.g., five (5), or the like) for each of the one or more reconstructed image frames based on the received user input (or the desired level of compression). The data distribution model 302f may fragment each of the one or more reconstructed image frames based on the determined number of fragments. The data distribution model 302f may analyze, using one or more distribution mechanisms (e.g., normal distribution, or the like), content variation within each of the one or more reconstructed image frames to compute optimal fragments for each of the one or more reconstructed image frames (e.g., to generate one or more optimal fragmented image frames). The data distribution model 302f may perform a pixel binning operation, using one or more statistical mechanisms (e.g., Gaussian Mixture Models (GMMs)) on the one or more optimal fragmented image frames. Each of the one or more optimal fragmented image frames may include a group of pixels with a similar characteristic (such as, but not limited to, regions with similar texture, similar deviation from mean, or the like). The data distribution model 302f may perform the pixel binning operation on one or more fragments (or regions) of each of the one or more optimal fragmented image frames to generate the set of first representative data points for each of the one or more optimal fragmented image frames. The set of first representative data points may represent a scalar value for each of the one or more fragments (or optimal fragmented image frames).

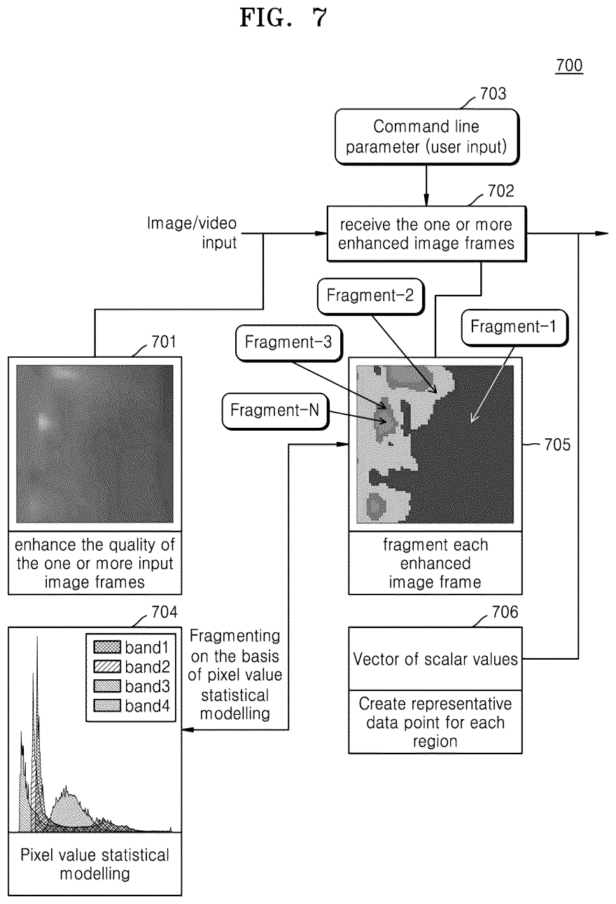

In one or more embodiments of the disclosure, the ground truth data distribution model 302g may generate a set of second representative data points, as described with reference to FIG. 7. The ground truth data distribution model 302g may execute multiple operations to generate the set of second representative data points.

The ground truth data distribution model 302g may receive (or identify) one or more input image frames associated with the input video (e.g., original video, uncompressed video). The ground truth data distribution model 302g may receive (or identify) a user input indicating a desired level of compression for each of the one or more input image frames. The ground truth data distribution model 302g may determine a number of fragments for each of the one or more input image frames based on the received user input (or the desired level of compression). The ground truth data distribution model 302g may fragment each of the one or more input image frames based on the determined number of fragments. The ground truth data distribution model 302g may analyze, using one or more distribution mechanisms, content variation within each of the one or more input image frame to compute optimal fragments for each of the one or more input image frames (e.g., to generate one or more optimal fragmented input image frames). The ground truth data distribution model 302g may perform the pixel binning operation, using one or more statistical mechanisms, on the one or more optimal fragmented input image frames. Each of the one or more optimal fragmented input image frames may include a group (or region) of pixels with a similar characteristic. The ground truth data distribution model 302g may perform the pixel binning operation on one or more fragments (or regions) of each of the one or more optimal fragmented input image frames to generate the set of second representative data points for each of the one or more optimal fragmented input image frames. The set of second representative data points may represent a scalar value for each of the one or more fragments (or optimal fragmented image frames).

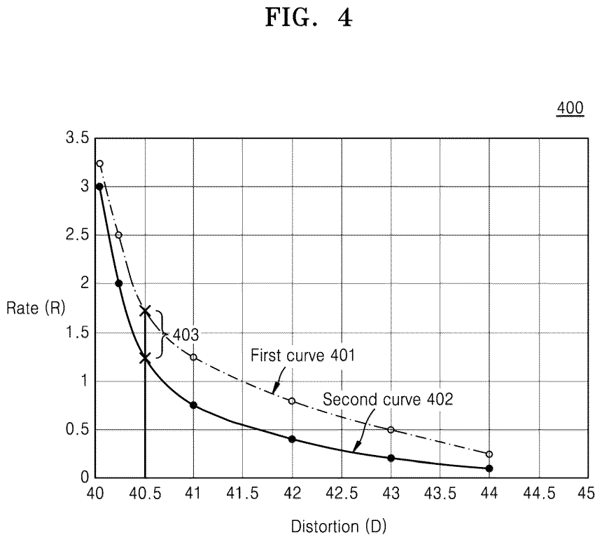

In one or more embodiments of the disclosure, the RDO-controlled mapping extent module 302h may determine overall RD cost based on an output of the RD cost module 304 and the user input regarding the number of fragments, as described with reference to FIG. 4. The RDO-controlled mapping extent module 302h may construct an objective function, which may be represented as a mathematical equation. The objective function may take as input an updated rate and/or distortion, along with previous RDO cost. Based on the updated RDO cost, the RD cost module 304 may determine whether to optimize the overall RD cost by minimizing the rate, the distortion, or both.

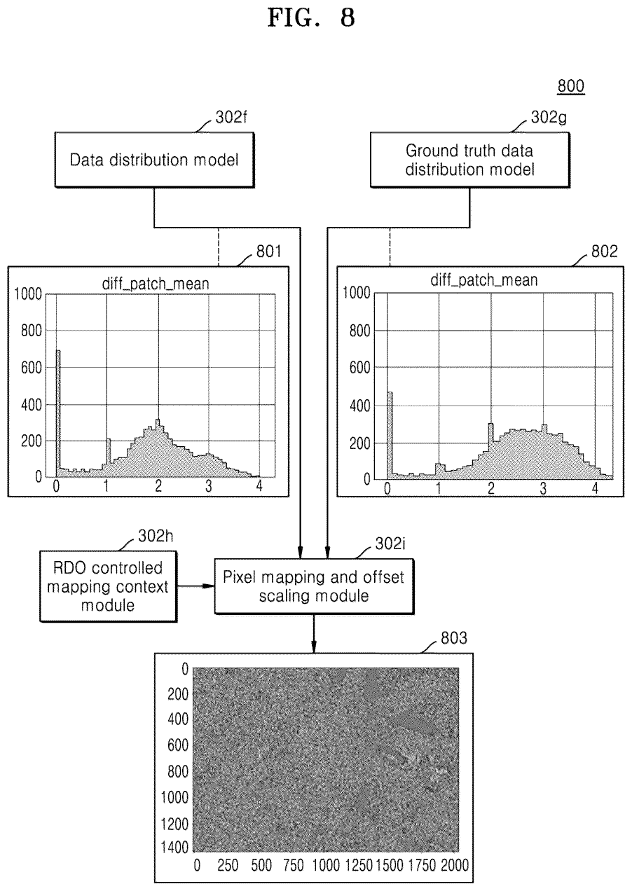

In one or more embodiments of the disclosure, the pixel mapping for offset scaling module 302i may determine a data distribution dissimilarity metric between the set of first representative data points for each fragmented image frame associated with the reconstructed video and the set of second representative data points for each fragmented input image frame associated with the input video, as described with reference to FIG. 8. The pixel mapping for offset scaling module 302i may further determine an offset value for each fragmented image frame by utilizing the data distribution dissimilarity metric, as described with reference to FIG. 8. The offset value may be computed and/or used at a per-fragment granularity. The number of fragments may be received as an input from the user. Each fragment may be computed during a data distribution modelling operation (e.g., data distribution dissimilarity metric).

In one or more embodiments of the disclosure, the pixel mapping for offset scaling module 302i may determine (or compute) a (prospective) pixel mapping in the form of per fragment offset using the model output data distribution, the ground-truth data distribution, and a mapping extent (e.g., the RDO-controlled mapping extent). The pixel mapping may be and/or may include pixel level domain mapping based on differences in the modelled distributions. The mapping extent may indicate whether to apply the offset scaling for a particular fragment on a basis of RD cost. The mapping extent may be determined using a user-defined number of fragments and output of the RD cost module 304 (e.g., codec RD cost).

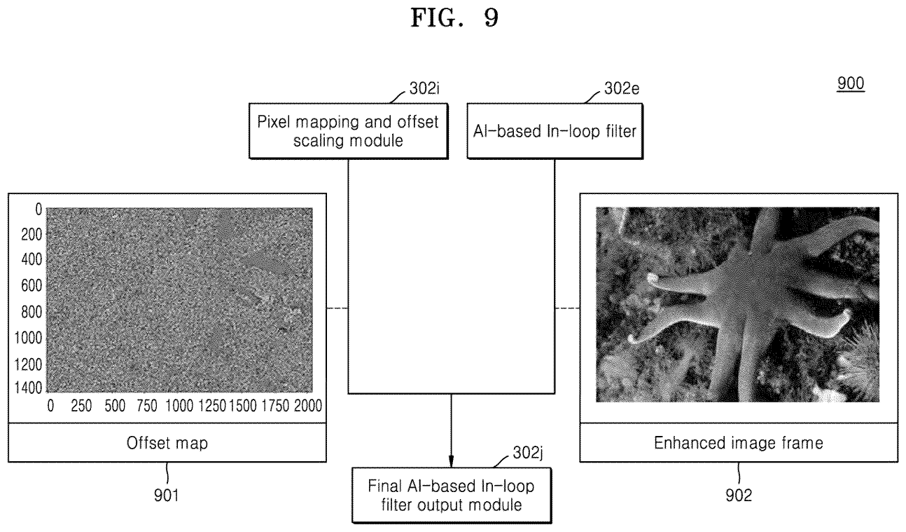

In one or more embodiments of the disclosure, the final AI-based in-loop filter output module 302j may perform a scaling operation for each pixel value associated with each fragmented image frame by utilizing the determined offset value, as described with reference to FIG. 9. Examples of the scaling operation may include, but are not limited to, an addition operation, a multiplication operation, a divisional operation, or an exponential operation. The final AI-based in-loop filter output module 302j may further enhance the reconstructed video based on the performed scaling operation.

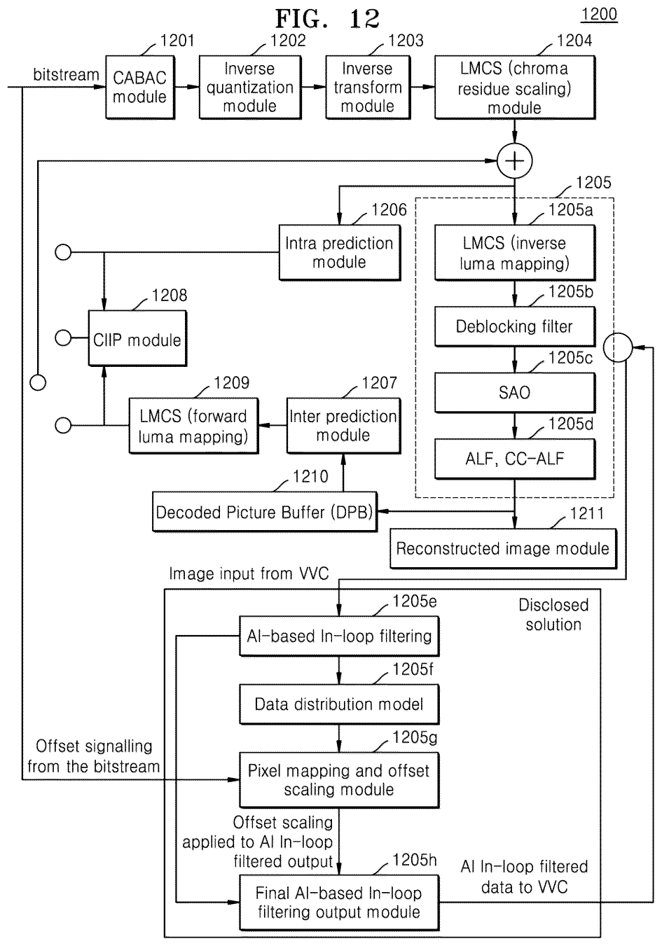

In one or more embodiments of the disclosure, the encoder may transmit bitstream information associated with the reconstructed video to a decoder, as described with reference to FIG. 12. The bitstream information may include the determined offset value (e.g., offset signalling).

The CABAC module 303 and the RD cost module 304 may be used in the VVC encoder, which may conform to one or more video coding standards. The CABAC module 303 may be and/or may include an entropy coding technique employed in the VVC encoder to compress the transformed and quantized coefficients. In the VVC encoder, the CABAC module 303 may be configured to compress the input video data and perform at least one of context modeling, binary arithmetic coding, or bitstream generation.

The CABAC module 303 may, as part of the context modeling, analyze the input video data (e.g., input video, image frame, or the like) and create statistical models that may capture the relationships and/or dependencies between symbols in the input video data. The CABAC module 303 may estimate probabilities of different symbols occurring based on context associated with the input video data.

The CABAC module 303 may, as part of the binary arithmetic coding, convert the probabilities into cumulative distribution functions (CDFs). The CDFs may be used to assign binary codewords to the symbols in the input video data. The binary arithmetic coding technique may encode the symbols based on the probabilities.

The CABAC module 303 may, as part of the bitstream generation, generate a compressed bitstream that may contain the encoded symbols, along with the necessary information for the decoder to reconstruct the input video data. The compressed bitstream may be transmitted and/or stored for further processing and/or transmission.

The RD cost module 304 may be configured to determine an optimal trade-off between rate (e.g., bitrate) and distortion (e.g., visual quality), which may assist the VVC encoder to find preferred coding parameters for each coding unit by evaluating the rate and distortion of different encoding options. The RD cost module 304 may perform various operations for encoding the input video data.

For example, the RD cost module 304 may estimate the number of bits required to represent the encoded data for a particular coding option. In such an example, the RD cost module 304 may estimate the bits used for coding syntax elements, motion information, and/or residual data.

Alternatively or additionally, the RD cost module 304 may, to assess the visual quality, calculate the distortion by comparing the reconstructed video to the original input. Common metrics that may include, but not be limited to, MSE, structural similarity index (SSIM), or the like may be used for distortion measurement.

As an example, the RD cost module 304 may perform rate distortion optimization by evaluating various coding options for each coding unit. In such an example, the RD cost module 304 may explore different modes, motion vectors, transform options, or quantization parameters to find the combination that may achieve a preferred trade-off between rate and distortion.

Based on the rate and distortion calculations, the RD cost module 304 may select the coding options that may minimize the overall RD cost. These optimal choices may be used for the final encoding of the input video data.

By incorporating the RD cost module 304, the VVC encoder may allocate bits based on the content characteristics and perceptual importance, which may result in improved video compression performance while maintaining satisfactory visual quality, when compared to related VVC encoders.

FIG. 4 illustrates an example of a rate distortion plot 400 to determine the RD cost value for each compressed image frame for the AI-based encoding of the media, according to an embodiment of the disclosure.

The RD cost module 304 may obtain the user preference for the amount of compression of the media and the quality of the compressed media. The RD cost module 304 may determine the rate (R) value (e.g., bit rate) for each compressed image frame based on the amount (or extent) of compression according to an equation similar to Equation 1. The RD cost module 304 may determine the distortion (D) value for each compressed image frame based on the quality of compressed content according to an equation similar to Equation 2.

$$Rate ( R ) ∝ \frac{1}{compression - extent} \qquad [ Eq . 1 ]$$

$$Distortion ( D ) ∝ \frac{1}{compressed - content - quality} \qquad [ Eq . 2 ]$$

The RD cost module 304 may determine the tuning parameter A. The tuning parameter may be configured based on a current requirement (e.g., user preference for the amount of compression of media). The tuning parameter may allow for differential weightage of rate and/or distortion. The RD cost module 304 may determine the RD cost value for each compressed image frame based on the rate R, the distortion D, and the tuning parameter A, according to an equation similar to Equation 3.

$$RD cost value = R + D \times λ \qquad [ Eq . 3 ]$$

The rate distortion plot 400 may illustrate a plurality of the rate R values on the y-axis and a plurality of the distortion D values on the x-axis. In addition, the rate distortion plot illustrates a first curve 401 for a first tuning parameter λ₁ and a second curve 402 for a second tuning parameter λ₂.

Based on the current requirement of the user, the user may either lower the rate R values and/or the distortion D values, as shown in the rate distortion plot 400. That is, there may be a trade-off between the rate R values and the distortion D values. For example, as depicted at element 403, in a case in which the user request an output of the video codec pipeline to have a relatively high quality with a relatively low distortion, the distortion D value may be selected as 40.5 (e.g., D=40.5). However, the rate R value may be increased for reduced distortion. As shown in FIG. 4, a second rate R₂ value may either be associated with the second curve 402 (e.g., R₂≈1.25) and a first rate R₁ value may either be associated with the first curve 401 (e.g., R₁≈1.75). In such an example, if the user is attempting to optimize memory of an electronic device, the RD cost module 304 may select the second curve 402 with the lowest R-value (e.g., R₂<R₁).

FIG. 5 illustrates an exemplary architecture of a deep convolutional neural network (DCNN) 500 associated with the AI-based In-Loop Filter 302e to potentially enhance the quality of each compressed image frame (e.g., reconstructed image frame) for the AI-based encoding of the media, according to an embodiment of the disclosure.

The AI-based in-loop filter 302e may receive one or more input image frames from at least one of the compression module 301, the LMCS 302a, the DBF 302b, the SAO filter 302c, the ALF, and the CC-ALF 302d. The one or more input image frames may be represented by a first set of dimensions with a height and width with respect to the input image pixels and one or more first channels (e.g., H×W×C₁), where H may denote the height of a tensor, W may denote the width of the tensor, and C₁ may denote a number of channels in the tensor. The dimensions may correspond to the height and width of the one or more input image frames and the number of channels present in the tensor. The tensor may be structured so as to organize pixel values of the one or more image frames in a multi-dimensional array. The one or more input image frames may be passed through one or more DCNNs to potentially enhance the quality of the one or more input image frames. The one or more enhanced image frames may be represented by a second set of dimensions that may have the height and width with respect to the image pixels of the input image signals and one or more second channels (e.g., H×W×C₂). In one embodiment of the disclosure, the use of AI-based in-loop filter 302e for quality enhancement in the video codec pipeline may allow for a wider range of data variations to be managed since the AI-based modules may be trained to remove multiple types of artifacts (e.g., blocking artifacts, ringing artifacts, or the like).

In one embodiment of the disclosure, the AI-based in-loop filter 302e may be designed to prevent and/or correct for various types of compression artifacts. The corrections from such filters are in-loop, and as such, may affect corrections for future image frames as well. The AI-based in-loop filter 302e may transfer the one or more enhanced image frames to the data distribution model 302f for further processing, as described with reference to FIG. 6.

FIG. 6 illustrates an exemplary scenario 600 to generate the set of first representative data points, according to an embodiment of the disclosure. The enhanced image frame may be received from the AI-based in-loop filter 302e.

At operation 601, the AI-based in-loop filter 302e may receive the one or more input image frames (e.g., reconstructed image frames, compressed image frames) associated with the input video from at least one of the compression module 301, the LMCS 302a, the DBF 302b, the SAO filter 302c, the ALF 302d, or the CC-ALF 302d.

At operation 602, the AI-based in-loop filter 302e may enhance the quality of the one or more input image frames. The AI-based in-loop filter 302e may pass the one or more enhanced image frames to the data distribution model 302f for further processing.

At operations 603 and 604, the data distribution model 302f may receive (or identify) the one or more enhanced image frames from the AI-based in-loop filter 302e and may receive (or identify) the user input to determine the number of fragments for each enhanced image frame. For example, the user may specify a compression preference in a form of command line arguments.

At operations 605 and 606, the data distribution model 302f may analyze content variation within each enhanced image frame by utilizing the one or more distribution mechanisms to determine one or more optimal fragmented image frames. Each optimal fragmented image frame may include the group of pixels with the similar characteristic. In an embodiment of the disclosure, the data distribution model 302f may analyze content variation within each enhanced image frame to generate one or more optimal fragments for each enhanced image frame. The data distribution model 302f may perform the pixel binning for each enhanced image frame by utilizing the one or more statistical mechanisms. The data distribution model 302f may fragment each enhanced image frame based on at least one of the received user input, the analyzed content variation, or the pixel binning. For example, each enhanced image frame may include four (4) fragments and/or four (4) sections (e.g., a first fragment fragment-1, a second fragment fragment-2, a third fragment fragment-3, or the like), and each section may be represented by a particular band (e.g., a first band band1, a second band band2, a third band band3, a fourth band band4, or the like).

At operation 607, the data distribution model 302f may generate the set of first representative data points for each of the one or more optimal fragmented image frames. The set of first representative data points may represent a vector of a scalar value for each of the one or more optimal fragmented image frames. In an embodiment of the disclosure, the data distribution model 302f may perform the pixel binning for each of the one or more fragments within each optimal fragmented image frame to create the set of first representative data points for each optimal fragmented image frame. The set of first representative data points for each optimal fragmented image frame may represent a scalar value for each of the one or more fragments within each optimal fragmented image frame.

In one embodiment of the disclosure, the data distribution model 302f may fragment each enhanced image frame using, for example, but not limited to, a Gaussian Mixture (GM) model.

In one embodiment of the disclosure, each fragmented image frame may capture different types of content within each enhanced image frame. Hence, the method, according to an embodiment of the disclosure, may be able to customize the processing for multiple data variations. That is, different types of data variations may generate different types of internal data distributions, which may result in different types of fragments. Furthermore, since the disclosed method works on-the-fly, hence, pre-training may not be needed and the method may be able to generalize for all types of input data (e.g., image frame, input video, or the like).

FIG. 7 illustrates an exemplary scenario 700 to generate the set of second representative data points, according to an embodiment of the disclosure.

At operations 701 and 702, the ground truth data distribution model 302g may receive (or identify) the one or more input image frames associated with the input video (e.g., original video).

At operations 702 and 703, the ground truth data distribution model 302g may receive (or identify) the user input to determine the number of fragments for each input image frame. For example, the user may specify the fragment preference in the form of command line arguments.

At operations 704 and 705, the ground truth data distribution model 302g may analyze content variation within each input image frame by utilizing the one or more distribution mechanisms to determine one or more optimal fragmented input image frames. Each optimal fragmented input image frame may include the group of pixels with the similar characteristic. In an embodiment of the disclosure, the ground truth data distribution model 302g may analyze content variation within each input image frame to generate one or more optimal fragments for each input image frame. The ground truth data distribution model 302g may perform the pixel binning for each input image frame by utilizing the one or more statistical mechanisms. The ground truth data distribution model 302g may fragment each input image frame based on the received user input, the analyzed content variation, and the pixel binning. For example, each input image frame may include the four (4) fragments or four (4) sections (e.g., a first fragment fragment-1, a second fragment fragment-2, a third fragment fragment-3, or the like), and each section may be represented by a particular band (e.g., a first band band1, a second band band2, a third band band3, a fourth band band4, or the like).

At operation 706, the ground truth data distribution model 302g may generate the set of second representative data points for each of the one or more optimal fragmented input image frames. The set of second representative data points may represent the vector of the scalar value for each of the one or more optimal fragmented input image frames. In an embodiment of the disclosure, the ground truth data distribution model 302g may perform the pixel binning for each of the one or more fragments within each optimal fragmented input image frame to create the set of second representative data points for each optimal fragmented input image frame. The set of second representative data points for each optimal fragmented input image frame may represent a scalar value for each of the one or more fragments within each optimal fragmented input image frame.

In one embodiment of the disclosure, the ground truth data distribution model 302g may fragment each input image frame using, for example, but not limited to, the GM model.

In one embodiment of the disclosure, the one or more statistical mechanisms utilized by the data distribution model 302f may be substantially similar and/or the same as the one or more statistical mechanisms utilized by the ground truth data distribution model 302g.

FIG. 8 illustrates an exemplary scenario 800 for generating the pixel mapping for the offset scaling for the AI-based encoding of the media, according to an embodiment of the disclosure.

In one embodiment of the disclosure, the pixel mapping for offset scaling module 302i may receive (or identify) modeled data distribution information from the data distribution model 302f and the ground truth data distribution model 302g. The one or more distribution mechanisms utilized by the data distribution and the ground truth data distribution models 302f and 302g may be substantially similar and/or the same. Subsequently, the pixel mapping for offset scaling module 302i may compare the output of the data distribution and the ground truth data distribution models 302f and 302g and may determine a difference between the output of the data distribution and the ground truth data distribution models 302f and 302g. The fragment information (e.g., the first fragment fragment-1) along with the representative value of the domain (e.g., amplitude of the pixel binning curve, as illustrated in FIGS. 6 and 7) may already be present in the modeled data distributions. The pixel mapping for offset scaling module 302i may consider one fragment at a particular time instance and compute a transformation between the fragment domain representative value of the corresponding segments in the ground truth data (e.g., input image frame, fragmented input image frame) and the model output data (e.g., reconstructed image frame, enhanced image frame, fragmented image frame).

In one embodiment of the disclosure, the pixel mapping for offset scaling module 302i may receive (or identify) a mapping extent information (indicating whether to apply offset scaling for a particular fragment (e.g., the first fragment fragment-1)) from the RDO-controlled mapping extent module 302h. In one embodiment of the disclosure, the pixel mapping for offset scaling module 302i may compute the mapping extent based on an objective function from the RDO-controlled mapping extent module 302h. The mapping extent information may be determined by a function, which may be represented as an equation similar to Equation 4.

$$RDO controlled mapping extend = f ( user defined no . of fragments , codec RD cost ) \qquad [ Eq . 4 ]$$

Referring to Equation 4, f may represent an objective function that may minimize the overall RD cost constructed by the RDO-controlled mapping extent module 302h.

For example, the graph 801 may represent distribution modelling associated with the data distribution model 302f, and the graph 802 may represent distribution modelling associated with the ground truth data distribution model 302g. The graph 801 and the graph 802 may depict domain information for the first fragment fragment-1. The pixel mapping for offset scaling module 302i may determine the offset values using a mathematical operation (e.g., a mean operation) for the offset scaling. The mean value of data represented on the x-y axis of the graph 801 may be two (2), and the mean value of data represented on the x-y axis of the graph 802 may be 2.5. As a result, a domain difference mean value of 0.5 may be obtained (e.g., 2.5−2.0=0.5). To overcome the domain difference mean value, one or more optimization operations (e.g., addition, multiplication, or the like) may be executed and pixel values associated with the first fragment fragment-1 may be scaled to reduce the distortion. The above-mentioned process is performed for each fragment in the image frame. As a result, the pixel mapping for offset scaling module 302i may generate the offset map 803. The generated offset map 803 may be sent to the final AI-based in-loop filter output module 302j for further processing, as described with reference to FIG. 9.

FIG. 9 illustrates an exemplary scenario 900 for generating the offset scaling, according to an embodiment of the disclosure.

The final AI-based in-loop filter output module 302j may receive (or identify) the generated offset map 901 from the pixel mapping for offset scaling module 302i and the enhanced image frame 902 from the AI-based in-loop filter 302e. The final AI-based in-loop filter output module 302j may perform the offset scaling on the enhanced image frame 902 based on the generated offset map 901. As a result, the final AI-based in-loop filter output module 302j may generate a content base scaled output.

The method, according to an embodiment of the disclosure, may need a per-segment (or per-fragment) offset to be encoded in the bitstream information. The method, according to an embodiment of the disclosure, may not encode information associated with the data distribution model 302f and the ground truth data distribution model 302g. That is, no information about on-the-fly modeling may need to be provided in the bitstream. Hence, aspects of the present disclosure may not significantly increase the rate associated with the encoding process.

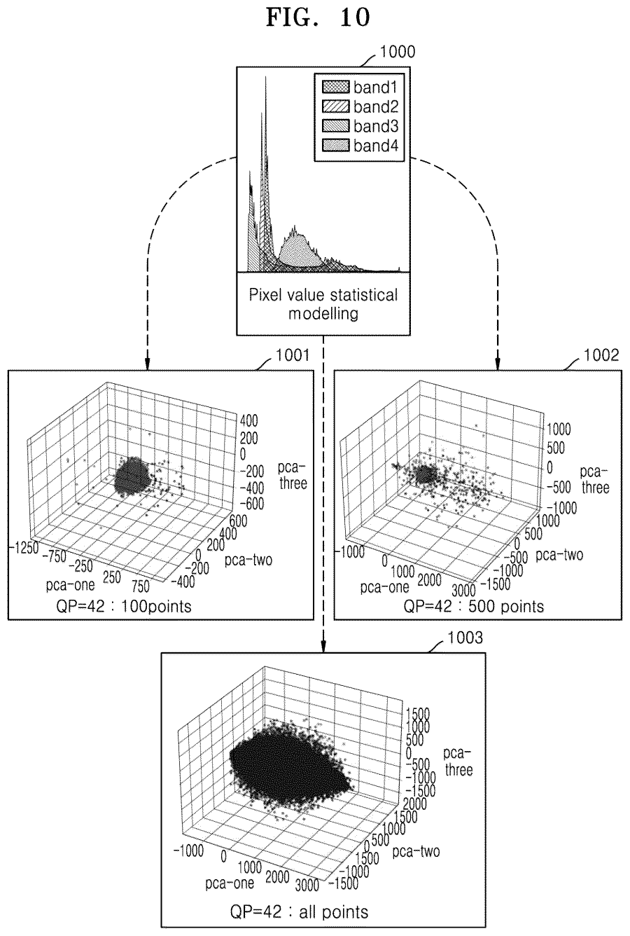

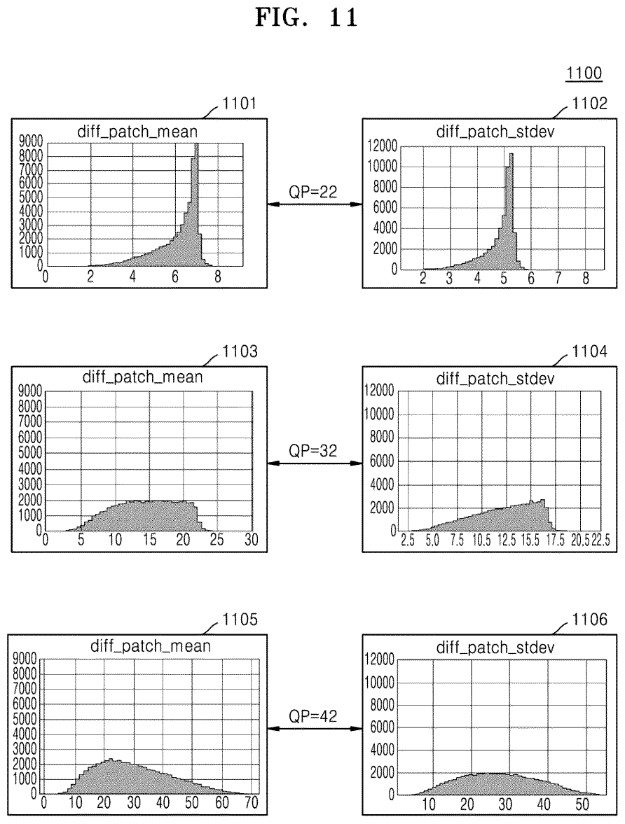

FIGS. 10 and 11 illustrate multiple ways of modeling a domain, according to an embodiment of the disclosure.

As shown in FIG. 10, a plot 1000 may represent the top three principal components (e.g., a first component pca-one, a second component pca-two, and a third component pca-three). The plot 1000 may visualize the pixel points in three-dimensional (3D) space. For example, a first plot may visualize one hundred (100) points with a first quantization parameter (QP) value (e.g., 42), a second plot may visualize five hundred (500) points with a second QP value (e.g., 42), and a third plot may visualize all points with a third QP value (e.g., 42). To compute representative points (e.g., the set of first representative data points and the set of second representative data points) using principal component analysis (PCA) methodology, the pixel mapping for offset scaling module 302i may transform the pixel values using the PCA methodology. Such a transformation may allow for the visualization of the transformed values as clusters. From these clusters (e.g., a first cluster 1001, a second cluster 1002, and a third cluster 1003), the pixel mapping for offset scaling module 302i may extract a cluster centroid, which may serve as a representative point for that particular cluster (e.g., the first cluster 1001, the second cluster 1002, and the third cluster 1003). The representative points may capture essential characteristics of the first to third clusters 1001 to 1003 and may be used for further analysis or decision-making processes.

Referring to FIG. 11, one or more graphs 1100 may represent, for example, mean and standard deviation modelling of pixel differences (hereinafter referred to as “diff”) between the ground truth data distribution model 302g and the data distribution model 302f, as described with reference to FIG. 8. When the QP value is 22, the first diff_patch_mean graph 1101 and the first diff_patch_stdfev graph 1102 may respectively display the mean and the standard deviation modelling of the pixel difference between the original data points (e.g., the set of second representative data points) and the codec recreated data points (e.g., the set of first representative data points). When the QP value is 32, the second diff_patch_mean graph 1103 and the second diff_patch_stdfev graph 1104 may respectively display the mean and standard deviation modelling of the pixel difference between the original data points and the codec recreated data points. When the QP value is 42, the third diff_patch_mean graph 1104 and the third diff_patch_stdfev graph 1105 may respectively display the mean and standard deviation modelling of the pixel difference between the original data points and the codec recreated data points.

FIG. 12 illustrates a block diagram of a VVC decoder pipeline 1200 for the AI-based encoding of the media, according to an embodiment of the disclosure.

The VVC decoder pipeline 1200 may include and/or may be similar in many respects to the VVC encoder pipeline described above with reference to FIG. 3, and may include additional features not mentioned above. Consequently, repeated descriptions of the VVC decoder pipeline 1200 described above with reference to FIG. 3 may be omitted for the sake of brevity.

The VVC decoder pipeline 1200 may include a plurality of modules. The plurality of modules may include a CABAC module 1201, an inverse quantization module 1202, an inverse transform module 1203, an LMCS 1204, an in-loop filters 1205, an intra prediction module 1206, an inter prediction module 1207, a CIIP module 1208, an LMCS 1209, a DPB 1210, and a reconstructed image module 1211.

The CABAC module 1201 may decompress compressed bitstreams (e.g., the bitstream information received from the VVC encoder pipeline 300) and may reconstruct the original frames (e.g., input video data).

The CABAC module 1201 may, as part of a bitstream parsing operation, receive the compressed bitstream and may parses the compressed bitstream to extract the encoded symbols and associated information.

The CABAC module 1201 may, as part of a binary arithmetic decoding operation, decode symbols from the compressed bitstream using binary arithmetic decoding. The CABAC module 1201 may assign probabilities to the decoded symbols and may use the probabilities to reconstruct original symbols associated with the encoded symbols.

The CABAC module 1201 may, as part of a context modeling synchronization operation, provide proper synchronization between the VVC encoder pipeline 300 and the VVC decoder pipeline 1200 using the context modeling.

The inverse quantization module 1202 and the inverse transform module 1203 may be configured to convert the quantized and transformed video data back into its original form. The LMCS module 1204 may be used to adjust chroma and/or luma components of the video data to potentially improve overall image quality.

The in-loop filters 1205 may receive the data from the LMCS module 1204. The in-loop filters 1205 may be configured to remove artifacts and noise that may occur during compression operations. Example of the in-loop filters 1205 may include a LMCS 1205a, a DBF 1205b, a SAO filter 1205c, an ALF 1205d, a CC-ALF 1205d, or the like. The in-loop filters 1205a to 1205d may include and/or may be similar in many respects to the in-loop filters described above with reference to FIG. 2A, and may include additional features not mentioned above. Consequently, repeated descriptions of the in-loop filters 1205a to 1205d described above with reference to FIG. 2A may be omitted for the sake of brevity.

The intra prediction module 1206 and the inter prediction module 1207 may be configured to predict the values of the data based on spatial and/or temporal correlations. The CIIP module 1208 may combine both intra and inter prediction techniques to potentially further improve compression efficiency. The DPB module 1210 and the reconstructed image module 1211 may work in conjunction to store and/or display decoded video data. For example, the DPB module 1210 may store previously decoded frames to enable inter-frame prediction, and the reconstructed image module 1211 may generate a high-quality display image from the decoded data (e.g., image frame from the in-loop filter 1205).

In one or more embodiments of the disclosure, the in-loop filters 1205 may include an AI-based in-loop filter 1205e, a data distribution model 1205f, a pixel mapping for offset scaling module 1205g, and a final AI-based in-loop filter output module 1205h.

In one or more embodiments of the disclosure, the AI-based in-loop filter 1205e may receive the bitstream information associated with the reconstructed video from the VVC encoder pipeline 300, as described with reference to FIG. 3. The bitstream information may include the offset value. The AI-based in-loop filter 1205e may include and/or may be similar in many respects to the AI-based in-loop filter 302e described above with reference to FIG. 3, and may include additional features not mentioned above. Consequently, repeated descriptions of the AI-based in-loop filter 1205e described above with reference to FIG. 3 may be omitted for the sake of brevity.

In one or more embodiments of the disclosure, the AI-based in-loop filter 1205e may receive (or identify) the reconstructed image frame associated with the reconstructed video from at least one of LMCS 1204, LMCS 1205a, deblocking filter 1205b, SAO 1205c, ALF 1205d, or CC-ALF 1205d. The AI-based in-loop filter 1205e may potentially enhance the quality of the reconstructed image frame by attempting to remove and/or correct for artifacts that may be present in the reconstructed image frame.

In one or more embodiments of the disclosure, the data distribution model 1205f may generate the model output data distribution for the reconstructed video. The data distribution model 1205f may generate the model output data distribution for the enhanced image frame from AI-based in-loop filter 1205e.

In one or more embodiments of the disclosure, the pixel mapping for offset scaling module 1205g may perform the scaling operation for each pixel value associated with each fragmented image frame of the reconstructed video by utilizing the offset value and the generated model output data distribution. In an embodiment of the disclosure, the pixel mapping for offset scaling module 1205g may identify the offset signalling from the bitstream and may generate an offset map based on the offset signalling.

In one or more embodiments of the disclosure, the final AI-based in-loop filter output module 1205h may generate an output video based on the performed scaling operation. In an embodiment of the disclosure, the final AI-based in-loop filter output module 1205h may perform the offset scaling operation on the enhanced image frame from the AI-based in-loop filtering 1205e based on the generated offset map (or offset values, offset signalling).

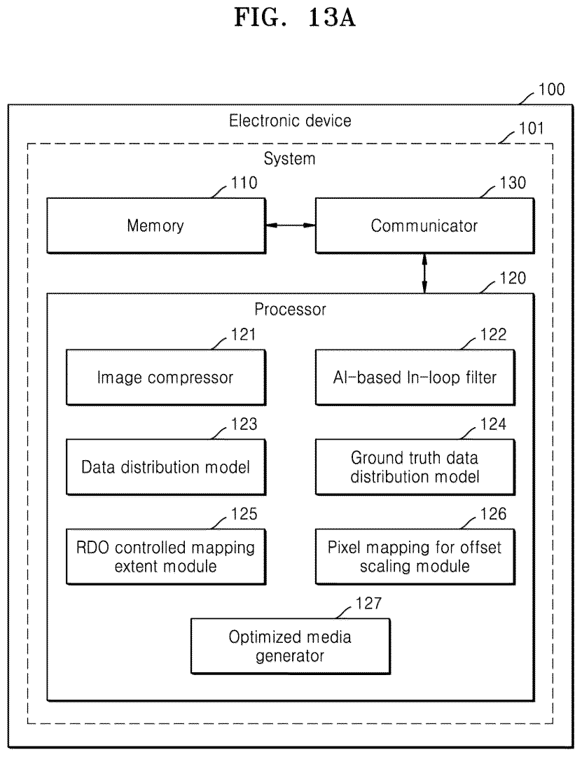

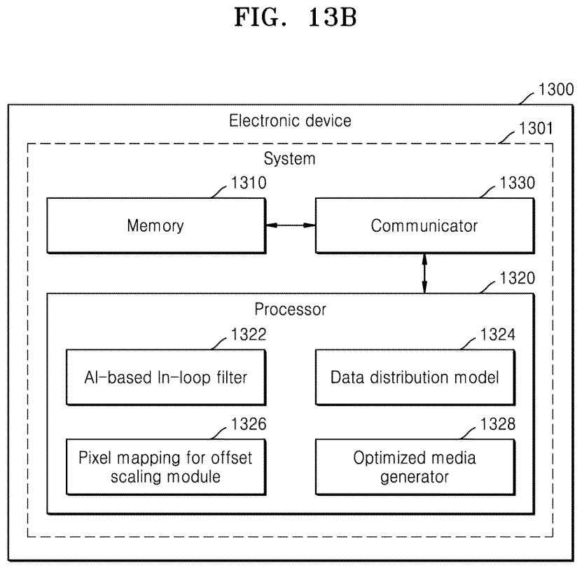

FIG. 13A illustrates a block diagram of an electronic device 100 for the AI-based encoding of the media, according to an embodiment of the disclosure. In one or more embodiments of the disclosure, the electronic device 100 may include one or more modules depicted in FIG. 3. Examples of the electronic device 100 may include, but are not limited to, a smartphone, a tablet computer, a personal digital assistant (PDA), an Internet of Things (IoT) device, a wearable device, or the like.

In an embodiment of the disclosure, the electronic device 100 may include a system 101. The system 101 may include memory 110, a processor 120, and a communicator 130.

In an embodiment of the disclosure, the memory 110 may store instructions to be executed by the processor 120 for AI-based encoding of the media, as discussed throughout the present disclosure. The memory 110 may include non-volatile storage elements. Examples of such non-volatile storage elements may include, but not be limited to, magnetic hard discs, optical discs, floppy discs, flash memories, forms of electrically programmable memories (EPROM) or electrically erasable and programmable (EEPROM) memories, or the like. Alternatively or additionally, the memory 110 may, in some examples, be considered a non-transitory storage medium. The term “non-transitory” may indicate that the storage medium is not embodied in a carrier wave or a propagated signal. However, the term “non-transitory” should not be interpreted to indicate that the memory 110 is non-movable. In one or more embodiments of the disclosure, the memory 110 may be configured to store larger amounts of information than the memory. In one or more embodiments of the disclosure, a non-transitory storage medium may store data that may, over time, change (e.g., in random access memory (RAM) or cache). The memory 110 may be and/or may include an internal storage unit. Alternatively or additionally, the memory 110 may be and/or may include an external storage unit of the electronic device 100, a cloud storage, or any other type of external storage.

The processor 120 may communicate with the memory 110 and the communicator 130. The processor 120 may be configured to execute instructions stored in the memory 110 and to perform various processes for AI-based encoding of the media, as discussed throughout the present disclosure. The processor 120 may include one or a plurality of processors, may be and/or may include a general purpose (GP) processor (e.g., a central processing unit (CPU), an application processor (AP), or the like), a graphics-only processing unit (e.g., a graphics processing unit (GPU), a visual processing unit (VPU), or the like), and/or an AI dedicated processor (e.g., a neural processing unit (NPU), or the like).

The communicator 130 may be configured for communicating internally between internal hardware components and with external devices (e.g., server) via one or more networks (e.g., radio technology). The communicator 130 may include an electronic circuit that may conform to one or more telecommunication standards that may enable wired and/or wireless communications.

The processor 120 may be implemented by processing circuitry such as, but not limited to, logic gates, integrated circuits, microprocessors, microcontrollers, memory circuits, passive electronic components, active electronic components, optical components, hardwired circuits, or the like, and may optionally be driven by firmware and/or software. The circuits may, for example, be embodied in one or more semiconductor chips, or on substrate supports such as, but not limited to, PCBs or the like.

In one embodiment of the disclosure, the processor 120 may include an image compressor 121, an AI-based in-loop filter 122, a data distribution model 123, a ground truth data distribution model 124, an RDO-controlled mapping extent module 125, a pixel mapping for offset scaling module 126, and an optimized media generator 127.

The image compressor 121, the AI-based in-loop filter 122, the data distribution model 123, the ground truth data distribution model 124, the RDO-controlled mapping extent module 125, the pixel mapping for offset scaling module 126, and the optimized media generator 127 may respectively include and/or may be similar in many respects to the compression module 301, the AI-based in-loop filter 302e, the data distribution model 302f, the ground truth data distribution model 302g, the RDO-controlled mapping context module 302h, the pixel mapping for offset scaling module 302i, and the final AI-based in-loop filter output module 302j described above with reference to FIG. 3, and may include additional features not mentioned above. Consequently, repeated descriptions of these components described above with reference to FIG. 3 may be omitted for the sake of brevity.

The image compressor 121 may receive the input video. The image compressor 121 may perform one or more pre-defined compression operations on the received input video such as, but not limited to, the transformation, the quantization, the de-quantization, and the inverse transformation.

The AI-based in-loop filter 122 may be configured to apply the AI techniques in the loop-filtering process of video coding. The AI-based in-loop filter 122 may enhance the performance of the in-loop filters 302a to 302d. The AI-based in-loop filter 122 may leverage the machine learning models to learn the characteristics of video content (e.g., input video, or the like) and may apply adaptive filtering techniques. That is, instead of relying on predefined rules or heuristics, the AI-based in-loop filter 122 may use neural networks and/or other AI methodologies to analyze and/or process the video content. For example, the AI-based in-loop filter 122 may use AI models that may learn from relatively large amounts of training data and make comparatively intelligent decisions regarding the filtering operations. The AI-based in-loop filter 122 may generate the one or more reconstructed image frames and may send the one or more reconstructed image frames to the data distribution model 123 for further processing.

The data distribution model 123 may generate the set of first representative data points, as described with reference to FIG. 6. The data distribution model 123 may execute multiple operations to generate the set of first representative data points.

The data distribution model 123 may receive the one or more reconstructed image frames (e.g., one or more enhanced image frames) from the AI-based in-loop filter 122. The one or more reconstructed image frames may be associated with the reconstructed video. The data distribution model 123 may receive the user input indicating the desired level of compression for each of the one or more reconstructed image frames. The data distribution model 123 may determine the number of fragments for each of the one or more reconstructed image frames based on the received user input. The data distribution model 123 may fragment each of the one or more reconstructed image frames based on the determined number of fragments. The data distribution model 123 may analyze, using the one or more distribution mechanisms, content variation within each fragmented image frame. The data distribution model 123 may perform the pixel binning operation, using the one or more statistical mechanisms, on the analyzed content variation to determine one or more optimal fragmented image frames. Each of the one or more optimal fragmented image frames may include the group of pixels with the similar characteristic. The data distribution model 123 may generate the set of first representative data points for each of the one or more optimal fragmented image frames.

The ground truth data distribution model 124 may generate the set of second representative data points, as described with reference to FIG. 7. The ground truth data distribution model 124 may execute multiple operations to generate the set of second representative data points.

The ground truth data distribution model 124 may receive the one or more input image frames associated with the input video. The ground truth data distribution model 124 may receive the user input indicating the desired level of compression for each of the one or more input image frames. The ground truth data distribution model 124 may determine the number of fragments for each of the one or more input image frames based on the received user input. The ground truth data distribution model 124 may fragment each of the one or more input image frames based on the determined number of fragments. The ground truth data distribution model 124 may analyze, using the one or more distribution mechanisms, content variation within each fragmented input image frame. The ground truth data distribution model 124 may perform the pixel binning operation, using the one or more statistical mechanisms, on the analyzed content variation to determine the one or more optimal fragmented image frames. Each of the one or more optimal fragmented image frames may include the group of pixels with the similar characteristic. The ground truth data distribution model 124 may generate the set of second representative data points for each of the one or more optimal fragmented image frames.

The RDO-controlled mapping extent module 125 may determine the overall RD cost based on the output of the RD cost module 304 and the user input regarding the number of fragments, as described with reference to FIG. 4. The RDO-controlled mapping extent module 125 may further construct the objective function that may minimize the overall RD cost.

The pixel mapping for offset scaling module 126 may determine the data distribution dissimilarity metric between the set of first representative data points for each fragmented image frame associated with the reconstructed video and the set of second representative data points for each fragmented image frame associated with the input video, as described with reference to FIG. 8. The pixel mapping for offset scaling module 126 may further determine the offset value for each fragmented image frame by utilizing the data distribution dissimilarity metric, as described with reference to FIG. 8.

The optimized media generator 127 may perform the scaling operation for each pixel value associated with each fragmented image frame by utilizing the determined offset value, as described with reference to FIG. 9. The optimized media generator 127 may further encode the reconstructed video based on the performed scaling operation.

A function associated with the various components of the electronic device 100 may be performed through the non-volatile memory, the volatile memory, and the processor 120. One or a plurality of processors may control the processing of the input data in accordance with a predefined operating rule or AI model that may be stored in the non-volatile memory and/or the volatile memory. The predefined operating rule or AI model may be provided through training and/or learning. As used herein, being provided through learning may refer to applying a learning algorithm to a plurality of learning data, in order to obtain a predefined operating rule, or AI model of a desired characteristic. The learning may be performed in the device itself (e.g., electronic device 100) in which the AI according to an embodiment of the disclosure may be performed, and/or may be implemented through a separate server and/or system. The learning algorithm may be and/or may include a method for training a predetermined target device (e.g., a robot) using a plurality of learning data to cause, allow, or control the target device to decide and/or to predict. Examples of learning methodology may include, but are not limited to, supervised learning, unsupervised learning, semi-supervised learning, reinforcement learning, or the like.

The AI model may be and/or may include a plurality of neural network layers. Each layer may have a plurality of weight values and may perform a layer operation through a calculation of a previous layer and an operation of a plurality of weights. Examples of neural networks may include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), deep Q-networks, or the like.

Although FIG. 13A shows various hardware components of the electronic device 100, it is to be understood that the present disclosure is not limited thereon. In one or more embodiments of the disclosure, the electronic device 100 may include fewer or additional components. Further, the labels and/or names of the components are used only for illustrative purposes and may not limit the scope of the present disclosure. One or more components may be combined to perform substantially similar and/or the same functions for AI-based encoding of the media.

FIG. 13B illustrates a block diagram of an electronic device 1300 for the AI-based decoding of the media, according to an embodiment of the disclosure. In one or more embodiments of the disclosure, the electronic device 1300 may include one or more modules depicted in FIG. 12. Examples of the electronic device 1300 may include, but are not limited to, a smartphone, a tablet computer, a PDA, an IoT device, a wearable device, or the like.

In an embodiment of the disclosure, the electronic device 1300 may include a system 1301. The system 1301 may include memory 1310, a processor 1320, and a communicator 1330.

In an embodiment of the disclosure, the memory 1310 may store instructions to be executed by the processor 1320 for AI-based decoding of the media, as discussed throughout the present disclosure. The memory 1310 may include non-volatile storage elements. Examples of such non-volatile storage elements may include, but not be limited to, magnetic hard discs, optical discs, floppy discs, flash memories, forms of EPROM or EEPROM memories, or the like. In addition, the memory 1310 may, in some examples, be considered a non-transitory storage medium. In some examples, the memory 1310 may be configured to store larger amounts of information than the memory. In certain examples, a non-transitory storage medium may store data that may, over time, change (e.g., in RAM or cache). The memory 1310 may be and/or may include an internal storage unit, and/or the memory 1310 may be and/or may include an external storage unit of the electronic device 1300, a cloud storage, or any other type of external storage.

The processor 1320 may communicate with the memory 1310 and the communicator 1330. The processor 1320 may be configured to execute instructions stored in the memory 1310 and to perform various processes for AI-based encoding-decoding of the media, as discussed throughout the present disclosure. The processor 1320 may include one or a plurality of processors, and may be and/or may include a general-purpose processor (e.g., a CPU, an AP, or the like), a graphics-only processing unit (e.g., GPU, a VPU), and/or an AI dedicated processor (e.g., a NPU).

The communicator 1330 may be configured to communicate internally between internal hardware components and with external devices (e.g., server) via one or more networks (e.g., radio technology). The communicator 1330 may include one or more electronic circuits that may conform to one or more telecommunication standards that may enable wired or wireless communications.

The processor 1320 may be implemented by processing circuitry such as logic gates, integrated circuits, microprocessors, microcontrollers, memory circuits, passive electronic components, active electronic components, optical components, hardwired circuits, or the like, and may optionally be driven by firmware or software. The circuits may, for example, be embodied in one or more semiconductor chips, or on substrate supports such as, but not limited to, PCBs or the like.

In one embodiment of the disclosure, the processor 1320 may include an AI-based in-loop filter 1322, a data distribution model 1324, a pixel mapping for offset scaling module 1326, and an optimized media generator 1328.

The AI-based in-loop filter 1322, the data distribution model 1324, the pixel mapping for offset scaling module 1326, and the optimized media generator 1328 may respectively include and/or may be similar in many respects to the AI-based in-loop filter 1205e, the data distribution model 1205f, the pixel mapping for offset scaling module 1205g, and the final AI-based in-loop filter output module 1205h described above with reference to FIG. 12, and may include additional features not mentioned above. Consequently, repeated descriptions of these components described above with reference to FIG. 12 may be omitted for the sake of brevity.

The AI-based in-loop filter 1322 may be configured to apply the AI techniques in the loop-filtering process of video decoding. The AI-based in-loop filter 1322 may enhance the performance of the in-loop filters 302a to 302d. The AI-based in-loop filter 1322 may leverage the machine learning models to learn the characteristics of video content (e.g., input video, or the like) and may apply adaptive filtering techniques. Instead of relying on predefined rules or heuristics, the AI-based in-loop filter 1322 may use neural networks or other AI methodologies to analyze and/or process the video content. The AI-based in-loop filter 1322 may use AI models, and the AI models may learn from relatively large amounts of training data and make comparatively intelligent decisions regarding the filtering operations. The AI-based in-loop filter 1322 may generate the one or more reconstructed image frames and may send the one or more reconstructed image frames to the data distribution model 1324 for further processing.

The data distribution model 1324 may generate the set of first representative data points, as described with reference to FIG. 6. The data distribution model 123 may execute multiple operations to generate the set of first representative data points.

The data distribution model 1324 may receive the one or more reconstructed image frames (e.g., one or more enhanced image frames) from the AI-based in-loop filter 1322. The one or more reconstructed image frames may be associated with the reconstructed video. The data distribution model 1324 may receive the user input indicating the desired level of compression for each of the one or more reconstructed image frames. The data distribution model 1324 may determine the number of fragments for each of the one or more reconstructed image frames based on the received user input. The data distribution model 1324 may fragment each of the one or more reconstructed image frames based on the determined number of fragments. The data distribution model 1324 may analyze, using the one or more distribution mechanisms, content variation within each fragmented image frame. The data distribution model 1324 may perform the pixel binning operation, using the one or more statistical mechanisms, on the analyzed content variation to determine one or more optimal fragmented image frames. Each of the one or more optimal fragmented image frames may include the group of pixels with the similar characteristic. The data distribution model 1324 may generates the set of first representative data points for each of the one or more optimal fragmented image frames.

The pixel mapping for offset scaling module 1326 may perform a pixel mapping for the scaling operation based on offset information included in bitstream information from the encoder, as described with reference to FIG. 8.

The optimized media generator 1328 may perform the scaling operation on the reconstructed image frame based on the pixel mapping to generate the scaled image frame. The optimized media generator 1328 may perform the scaling operation for each pixel value associated with each fragmented image frame by utilizing the offset information (e.g., value), as described with reference to FIG. 9. The optimized media generator 1328 may generate an output video based on the scaled image frame.

Alternatively or additionally, the optimized media generator 1328 may receive the bitstream information associated with the reconstructed video from the encoder (e.g., VVC encoder pipeline 300). The bitstream information may include the offset value. The optimized media generator 1328 may generate the model output data distribution for the reconstructed video by utilizing the offset value by using the data distribution model 1205f. The optimized media generator 1328 may perform the scaling operation for each pixel value associated with each fragmented image frame of the reconstructed video by utilizing the offset value and the generated model output data distribution by using the pixel mapping for offset scaling module 1205g. The optimized media generator 1328 may generate the output video based on the performed scaling operation by using the final AI-based in-loop filtering output module 1205h.

A function associated with the various components of the electronic device 1300 may be performed through the non-volatile memory, the volatile memory, and the processor 1320. One or a plurality of processors may control the processing of the input data in accordance with a predefined operating rule and/or AI model that may be stored in the non-volatile memory and/or the volatile memory. The predefined operating rule or AI model may be provided through training and/or learning.

The AI model may be and/or may include a plurality of neural network layers. Each layer may have a plurality of weight values and may perform a layer operation through a calculation of a previous layer and an operation of a plurality of weights. Examples of neural networks may include, but not be limited to, CNN, DNN, RNN, RBM, DBN, BRDNN, GAN, deep Q-networks, or the like.

Although FIG. 13B shows various hardware components of the electronic device 1300, it is to be understood that the present disclosure is not limited thereon. In one or more embodiments of the disclosure, the electronic device 1300 may include fewer or additional components. Further, the labels and/or names of the components may be used only for illustrative purposes and may not limit the scope of the present disclosure. One or more components may be combined to perform substantially similar and/or the same functions for AI-based encoding-decoding of the media.

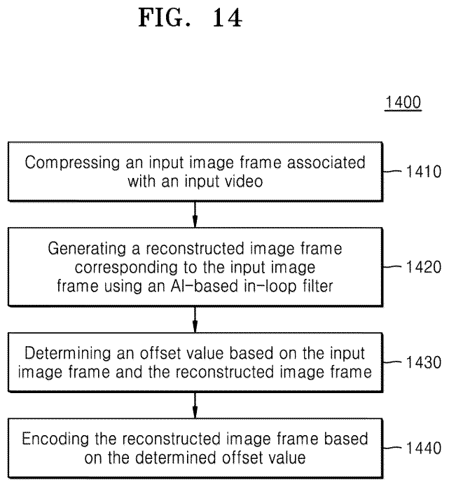

FIG. 14 is a flow diagram illustrating a method 1400 performed by an electronic device for the AI-based encoding of media, according to an embodiment of the disclosure.

At operation 1410, the method 1400 may include compressing an input image associated with an input video. In an embodiment of the disclosure, the method 1400 may include compressing the input video for feeding into an AI-based in-loop filter, which may relate to at least one of the compression module 301, the in-loop filter 302 (e.g., LMCS 302a, deblocking filter 302b, SAO 302c, ALF 302d, CC-ALF 302d), CABAC module 303, or RD cost module 304 of FIG. 3.

At operation 1420, the method 1400 may include generating a reconstructed image frame corresponding to the input image frame using the AI-based in-loop filter 302e, which may relate to the output of the AI-based in-loop filter 302e of FIG. 3.

At operation 1430, the method 1400 may include generating an offset value based on the input image frame and the reconstructed image frame. In an embodiment of the disclosure, the method 1400 may include generating the model output data distribution for the reconstructed video, which may relate to the data distribution model 302f of FIG. 3. The method 1400 may include several processes to generate the model output data distribution for the reconstructed video. For example, the method 1400 may include receiving the one or more reconstructed image frames from the AI-based in-loop filter. The one or more reconstructed image frames may be associated with the reconstructed video. The one or more reconstructed image frames may be generated by utilizing one or more NN models. The method 1400 may further include receiving the user input indicating the desired level of compression for each of the one or more reconstructed image frames. The method 1400 may further include determining the number of fragments for each of the one or more reconstructed image frames based on the received user input. The method 1400 further includes fragmenting each of the one or more reconstructed image frames based on the determined number of fragments. The method 1400 may further include analyzing, using the one or more distribution mechanisms, the content variation within each fragmented image frame. The method 1400 may further includes performing the pixel binning operation, using one or more statistical mechanisms, on the analyzed content variation to determine one or more optimal fragmented image frames. Each of the one or more optimal fragmented image frames may include the group of pixels with the similar characteristic. The method 1400 may further include generating the set of first representative data points for each of the one or more optimal fragmented image frames.

In an embodiment of the disclosure, the method 1400 may include generating the ground truth data distribution for the input video, which may relate to the ground truth data distribution model 302g of FIG. 3. The method 1400 may include several processes to generate ground truth data distribution for the input video. For example, the method 1400 may include receiving the one or more input image frames associated with the input video. The method 1400 may further include receiving the user input indicating the desired level of compression for each of the one or more input image frames. The method 1400 may further include determining the number of fragments for each of the one or more input image frames based on the received user input. The method 1400 may further include fragmenting each of the one or more input image frames based on the determined number of fragments. The method 1400 may further include analyzing, using the one or more distribution mechanisms, content variation within each fragmented input image frame. The method 1400 may further include performing the pixel binning operation, using one or more statistical mechanisms, on the analyzed content variation to determine one or more optimal fragmented image frames. Each of the one or more optimal fragmented image frames may include the group of pixels with the similar characteristic. The method 1400 may further include generating the set of second representative data points for each of the one or more optimal fragmented image frames.

In an embodiment of the disclosure, the method 1400 may include determining the offset value by comparing the model output data distribution and the ground truth data distribution, which may relate to the pixel mapping for offset scaling module 302i of FIG. 3. The method 1400 may include several processes to determine the offset value. For example, the method 1400 may include determining the data distribution dissimilarity metric between the set of first representative data points for each fragmented image frame associated with the reconstructed video and the set of second representative data points for each fragmented image frame associated with the input video. The method 1400 may further include determining the offset value for each fragmented image frame by utilizing the data distribution dissimilarity metric.

At operation 1440, the method 1400 may include encoding the reconstructed image frame based on the determined offset value. In an embodiment of the disclosure, the method 1400 may include encoding the reconstructed video by utilizing the determined offset value, which may relate to at least one of the final AI-based in-loop filter output module 302j, the in-loop filters 302 (e.g., LMCS 302a, deblocking filter 302b, SAO 302c, ALF, CC-ALF 302d), CABAC module 303, or RD cost module 304 of FIG. 3. The method 1400 may include several processes to encode the reconstructed video. For example, the method 1400 may include performing the scaling operation for each pixel value associated with each fragmented image frame by utilizing the determined offset value. The scaling operation may include the at least one of the addition operation, the multiplication operation, the divisional operation, or the exponential operation. The method 1400 may further include encoding the reconstructed video based on the performed scaling operation.

In an embodiment of the disclosure, the method 1400 may include sending the bitstream information associated with the reconstructed video to the decoder. The bitstream information may include the determined offset value.

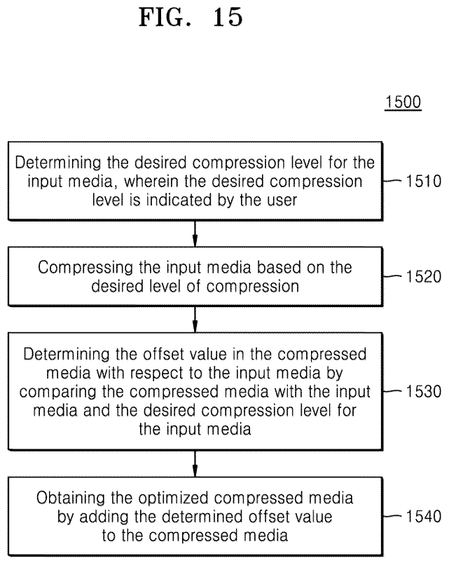

FIG. 15 is a flow diagram illustrating a method 1500 for the AI-based compressing of media, according to an embodiment of the disclosure. The method 1500 may relate to the method 1400.

At operation 1510, the method 1500 may include determining the desired compression level for the input media. The desired compression level may be indicated by the user.

At operation 1520, the method 1500 may include compressing the input media based on the desired level of compression, which may relate to operations 1410 and 1420 of FIG. 14.

At operation 1530, the method 1500 may include determining the offset value in the compressed media with respect to the input media by comparing the compressed media with the input media and the desired compression level for the input media, which may relate to operation 1430 of FIG. 14. The offset value may be computed and used at the per-fragment granularity. The number of fragments may be received as the input from the user. Each fragment may be computed during data distribution modelling operation. The method 1500 may include several processes to determine the offset value. The method 1500 may include modeling the model output data distribution. The method 1500 may further include modeling the ground truth data distribution. The method 1500 may further include determining the pixel mapping using the modeled model output data distribution, the modeled ground-truth data distribution, and the mapping extent. The mapping extent may indicate whether to apply the offset scaling for the particular fragment on the basis of RD cost. The mapping extent may be determined using the user-defined number of fragments and the codec RD cost.

At operation 1540, the method 1500 may include obtaining the optimized compressed media by adding the determined offset value to the compressed media, which may relate to operation 1440 of FIG. 14.

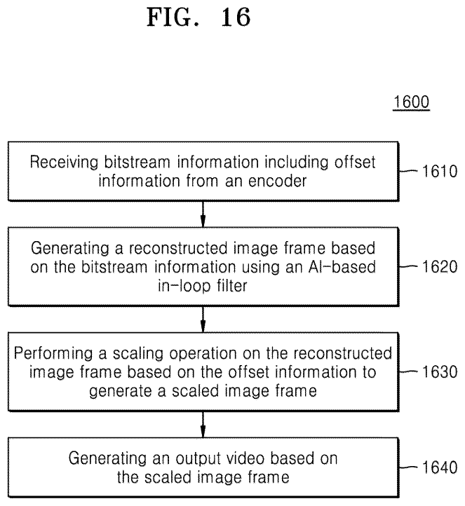

FIG. 16 is a flow diagram illustrating a method 1600 for the AI-based decoding of media, according to an embodiment of the disclosure.

At operation 1610, the method 1600 may include receiving bitstream information including offset information from the encoder. In an embodiment of the disclosure, the method 1600 may include receiving the bitstream information associated with the reconstructed video from the encoder. The bitstream information may include the offset value.

At operation 1620, the method 1600 may include generating a reconstructed image frame based on the bitstream information using an AI-based in-loop filter, which may related to at least one of the CABAC 1201, the inverse quantization module 1202, the inverse transform module 1203, LMCS module 1204, or the in-loop filter 1205 of FIG. 12. In an embodiment of the disclosure, the method 1600 may include generating the model output data distribution for the reconstructed video by utilizing the offset value.

At operation 1630, the method 1600 may include performing a scaling operation on the reconstructed image frame based on the offset information to generate a scaled image frame. In an embodiment of the disclosure, the method 1600 may include performing the scaling operation for each pixel value associated with each fragmented image frame of the reconstructed video by utilizing the offset value and the generated model output data distribution, which may relate to at least one of operation 1420 or operation 1430 of FIG. 14. The scaling operation may include at least one of the addition operation, the multiplication operation, the divisional operation, or the exponential operation.

At operation 1640, the method 1600 may include generating the output video based on the scaled image frame, which may related to at least one of the in-loop filter (e.g., LMCS 1205a, deblocking filter 1205b, SAO 1205c, ALF, CC-ALF 1205d) or the reconstructed image module 1211 of FIG. 12. In an embodiment of the disclosure, the method 1600 may include generating the output video based on the performed scaling operation.

In one or more embodiments of the disclosure, the bitstream information may include several tunable parameters. The parameters may include a tunable enhancement flag, a tunable number of classes, and a tunable class offset for offset scaling. For example, the tunable enhancement flag may be and/or may include a binary value. When the tunable enhancement flag is set to zero (0), the tunable enhancement flag may indicate that the bitstream information does not contain syntax elements related to tunable offset. Consequently, these syntax elements may not be used in the reconstruction process (refer to FIG. 12). The tunable number of classes may be another parameter that may be adjusted based on the requirements of the user to determine the number of classes to be considered during the processing (e.g., decoding). Alternatively or additionally, the tunable class offset parameter may specify the offsets to be applied to each class of pixels. These offsets may modify characteristics of the pixels within each class. By tuning these parameters within the bitstream information, the disclosed method may adapt to different scenarios and user preferences, allowing for customizable and flexible processing of the data.

In one or more embodiments of the disclosure, the disclosed method may provide a strategy for the AI-based model with an additional real-time module to adjust to newer and unseen data to reduce data domain gaps, as described with reference to FIGS. 3 to 16. The disclosed method may use pixel mapping and content-based scaling to bridge data domain gaps between newer/unseen data and training data in AI-based in-loop filters. As a result, the disclosed method may outperform related methods that may target particular artifacts and may be frequently trained using limited data, resulting in the inherent bias and volatility in AI-based trained models. The disclosed method may enable content-based scaling to identify the pixel mapping for scaling the offset value, operates on-the-fly, may not need pre-training, and may provide greater generalization for different types of data. Furthermore, the disclosed method may have a relatively low level of complexity when compared to related methods, as the related methods may deploy very complex DNN models to achieve higher gain, but may not be adaptive to a content-to-content basis. The disclosed method may address at least these issues by introducing video data-based statistical regression during an encoding process and using the same during a decoding process.

Unlike related methods that may target specific artifacts and may rely on limited training data, the disclosed method may use content-based scaling to bridge the data domain gaps and provide greater generalization for different types of data. Advantageously, the disclosed method may have the ability to identify the pixel mapping for scaling the offset without requiring pre-training. Such features ma allow for on-the-fly adjustments, which may be crucial in dynamic environments where data is constantly changing. Additionally, the disclosed method may have a relatively low level of complexity when compared to related methods that may rely on complex DNN models to achieve higher gain. The disclosed method may also address the issue of bias and volatility in AI-based trained models by introducing video data-based statistical regression during the encoding and decoding processes. This ensures that the disclosed method may be adaptive on a content-to-content basis and provides more accurate predictions. Overall, the disclosed method offers a powerful tool for improving AI-based models and addressing the challenges posed by newer and unseen data. Its ability to perform content-based scaling, bridge the data domain gaps, and provide greater generalization makes the electronic device 100 an essential tool for organizations looking to leverage AI technology in many operations (e.g., encoding, decoding, or the like).

In one or more embodiments of the disclosure, the disclosed method may have the potential to enhance the efficiency of the encoder and decoder in the electronic device 100, thereby reducing the video recording and memory requirements in the electronic device 100. Additionally, the disclosed method may facilitate superior video quality even in bandwidth-constrained scenarios. The disclosed method may significantly enhance the overall user experience and satisfaction. The benefits of the disclosed method may be particularly suited to a world, where video content consumption has become a norm, and bandwidth limitations may be prevalent.

In one or more embodiments of the disclosure, the disclosed method may enhance a Bjøntegaard-delta rate (BD-rate). The BD-rate gain may measure the overall compression efficiency of the entire pipeline. Alternatively or additionally, the disclosed method may enhances a visual quality of images by reducing distortion while keeping bandwidth requirements constant. Furthermore, the disclosed method may also reduce the bitstream or bandwidth requirements while maintaining the same visual quality. Furthermore, the disclosed method may enhance visual quality and also reduce bandwidth requirements.

In an embodiment of the disclosure, a method for AI based encoding of media may include compressing an input image frame associated with an input video. In an embodiment of the disclosure, the method may include generating a reconstructed image frame corresponding to the input image frame using an AI-based in-loop filter. In an embodiment of the disclosure, the method may include determining an offset value based on the input image frame and the reconstructed image frame. In an embodiment of the disclosure, the method may include encoding the reconstructed image frame based on the determined offset value.

In an embodiment of the disclosure, the determining of the offset value based on the input image frame and the reconstructed image frame may include generating a model output data distribution for the reconstructed image frame. In an embodiment of the disclosure, the determining of the offset value based on the input image frame and the reconstructed image frame may include generating a ground-truth data distribution for the input image frame. In an embodiment of the disclosure, the determining of the offset value based on the input image frame and the reconstructed image frame may include determining the offset value by comparing the model output data distribution and the ground-truth data distribution.

In an embodiment of the disclosure, the generating of the model output data distribution for the reconstructed image frame may include identifying a number of fragments for the reconstructed image frame based on a user input. In an embodiment of the disclosure, the generating of the model output data distribution for the reconstructed image frame may include analyzing, using one or more distribution mechanisms, content variation within the reconstructed image frame. In an embodiment of the disclosure, the generating of the model output data distribution for the reconstructed image frame may include fragmenting the reconstructed image frame based on the determined number of fragments and the analyzed content variation to generate an optimal fragmented image frame. In an embodiment of the disclosure, the generating of the model output data distribution for the reconstructed image frame may include performing a pixel binning operation, using one or more statistical mechanisms, on one or more fragments of the optimal fragmented image frame. In an embodiment of the disclosure, the optimal fragmented image frame may include a group of pixels with a similar characteristic. In an embodiment of the disclosure, the generating of the model output data distribution for the reconstructed image frame may include generating a set of first representative data points for the optimal fragmented image frame based on the pixel binning operation.

In an embodiment of the disclosure, the generating of the ground-truth data distribution for the input image frame may include identifying a number of fragments for the input image frame based on a user input. In an embodiment of the disclosure, the generating of the ground-truth data distribution for the input image frame may include analyzing, using one or more distribution mechanisms, content variation within the input image frame. In an embodiment of the disclosure, the generating of the ground-truth data distribution for the input image frame may include fragmenting the input image frame based on the determined number of fragments and the analyzed content variation to generate an optimal fragmented input image frame. In an embodiment of the disclosure, the generating of the ground-truth data distribution for the input image frame may include performing a pixel binning operation, using one or more statistical mechanisms, on one or more fragments of the optimal fragmented input image frame. In an embodiment of the disclosure, the optimal fragmented input image frame may include a group of pixels with a similar characteristic. In an embodiment of the disclosure, the generating of the ground-truth data distribution for the input image frame may include generating a set of second representative data points for the optimal fragmented input image frame based on the pixel binning operation.

In an embodiment of the disclosure, the determining of the offset value by comparing the model output data distribution and the ground-truth data distribution may include determining a data distribution dissimilarity metric between a set of first representative data points for an fragmented image frame from the reconstructed image frame and a set of second representative data points for an fragmented input image frame from the input image frame. In an embodiment of the disclosure, the determining of the offset value by comparing the model output data distribution and the ground-truth data distribution may include determining the offset value based on the data distribution dissimilarity metric.

In an embodiment of the disclosure, the determining of the offset value by comparing the model output data distribution and the ground-truth data distribution may include determining a pixel mapping using the model output data distribution, the ground-truth data distribution, and a mapping extent in a form of per-fragment offset.

In an embodiment of the disclosure, the mapping extent may be a decision of applying the offset scaling for a particular fragment on a basis of RD cost. In an embodiment of the disclosure, the mapping extent may be determined based on a number of fragments and a codec RD cost.

In an embodiment of the disclosure, the encoding of the reconstructed image frame may include performing a scaling operation on the reconstructed image frame based on the determined offset value to generate scaled image frame. In an embodiment of the disclosure, the scaling operation may include at least one of an addition operation, a multiplication operation, a divisional operation, or an exponential operation. In an embodiment of the disclosure, the encoding of the reconstructed image frame may include encoding the scaled image frame.

In an embodiment of the disclosure, the reconstructed image frame may be generated by utilizing one or more NN models of the AI-based in-loop filter.

In an embodiment of the disclosure, the method may include sending bitstream information associated with the reconstructed image frame to a decoder. In an embodiment of the disclosure, the bitstream information may include the determined offset value.

In an embodiment of the disclosure, the offset value may be computed and used at a per-fragment granularity.

In an embodiment of the disclosure, a method for AI based decoding of media may include receiving bitstream information including an offset information from an encoder. In an embodiment of the disclosure, the method may include generating a reconstructed image frame based on the bitstream information using an AI-based in-loop filter. In an embodiment of the disclosure, the method may include performing a scaling operation on the reconstructed image frame based on the offset information to generate a scaled image frame. In an embodiment of the disclosure, the method may include generating an output video based on the scaled image frame.

In an embodiment of the disclosure, the performing of the scaling operation on the reconstructed image frame may include generating a model output data distribution for the reconstructed image frame. In an embodiment of the disclosure, the performing of the scaling operation on the reconstructed image frame may include performing a pixel mapping for the scaling operation based on the offset information and the model output data distribution. In an embodiment of the disclosure, the performing of the scaling operation on the reconstructed image frame may include performing the scaling operation on the reconstructed image frame based on the pixel mapping to generate the scaled image frame.

In an embodiment of the disclosure, the scaling operation may include at least one of an addition operation, a multiplication operation, a divisional operation, or an exponential operation.

A system for AI based encoding of media may include a processor, operably connected to memory and a communicator. In an embodiment of the disclosure, the processor may be configured to compress an input image frame associated with an input video. In an embodiment of the disclosure, the processor may be configured to generate a reconstructed image frame corresponding to the input image frame using an AI-based in-loop filter. In an embodiment of the disclosure, the processor may be configured to determine an offset value based on the input image frame and the reconstructed image frame. In an embodiment of the disclosure, the processor may be configured to encode the reconstructed image frame based on the determined offset value.

In an embodiment of the disclosure, the processor may be configured to generate a model output data distribution for the reconstructed image frame. In an embodiment of the disclosure, the processor may be configured to generate a ground-truth data distribution for the input image frame. In an embodiment of the disclosure, the processor may be configured to determine the offset value by comparing the model output data distribution and the ground-truth data distribution.

In an embodiment of the disclosure, the processor may be configured to identify a number of fragments for the reconstructed image frame based on a user input. In an embodiment of the disclosure, the processor may be configured to analyze using one or more distribution mechanisms, content variation within the reconstructed image frame. In an embodiment of the disclosure, the processor may be configured to fragment the reconstructed image frame based on the determined number of fragments and the analyzed content variation to generate an optimal fragmented image frame. In an embodiment of the disclosure, the processor may be configured to perform a pixel binning operation, using one or more statistical mechanisms, on one or more fragments of the optimal fragmented image frame. In an embodiment of the disclosure, the optimal fragmented image frame may include a group of pixels with a similar characteristic. In an embodiment of the disclosure, the processor may be configured to generate a set of first representative data points for the optimal fragmented image frame based on the pixel binning operation.

In an embodiment of the disclosure, the processor may be configured to identify a number of fragments for the input image frame based on a user input. In an embodiment of the disclosure, the processor may be configured to analyze, using one or more distribution mechanisms, content variation within the input image frame. In an embodiment of the disclosure, the processor may be configured to fragment the input image frame based on the determined number of fragments and the analyzed content variation to generate an optimal fragmented input image frame. In an embodiment of the disclosure, the processor may be configured to perform a pixel binning operation, using one or more statistical mechanisms, on one or more fragments of the optimal fragmented input image frame. In an embodiment of the disclosure, the optimal fragmented input image frame may include a group of pixels with a similar characteristic. In an embodiment of the disclosure, the processor may be configured to generate a set of second representative data points for the optimal fragmented input image frame based on the pixel binning operation.

In an embodiment of the disclosure, the processor may be configured to determine a data distribution dissimilarity metric between a set of first representative data points for a fragmented image frame from the reconstructed image frame and a set of second representative data points for a fragmented input image frame from the input image frame. In an embodiment of the disclosure, the processor may be configured to determine the offset value based on the data distribution dissimilarity metric.

In an embodiment of the disclosure, the processor may be configured to determine a pixel mapping using the model output data distribution, the ground-truth data distribution, and a mapping extent in a form of per-fragment offset.

In an embodiment of the disclosure, the mapping extent may be a decision of applying the offset scaling for a particular fragment on a basis of RD cost. In an embodiment of the disclosure, the mapping extent may be determined based on a number of fragments and a codec RD cost.

In an embodiment of the disclosure, the processor may be configured to perform a scaling operation on the reconstructed image frame based on the determined offset value to generate scaled image frame. In an embodiment of the disclosure, the scaling operation may include at least one of an addition operation, a multiplication operation, a divisional operation, or an exponential operation. In an embodiment of the disclosure, the processor may be configured to encode the scaled image frame.

In an embodiment of the disclosure, the reconstructed image frame may be generated by utilizing one or more NN models of the AI-based in-loop filter.

In an embodiment of the disclosure, the processor may be configured to send bitstream information associated with the reconstructed image frame to a decoder. In an embodiment of the disclosure, the bitstream information may include the determined offset value.

In an embodiment of the disclosure, the offset value may be computed and used at a per-fragment granularity.

A system for AI based decoding of media may include a processor, operably connected to memory and a communicator. In an embodiment of the disclosure, the processor may be configured to receive bitstream information including an offset information from an encoder. In an embodiment of the disclosure, the processor may be configured to generate a reconstructed image frame based on the bitstream information using an AI-based in-loop filter. In an embodiment of the disclosure, the processor may be configured to perform a scaling operation on the reconstructed image frame based on the offset information to generate a scaled image frame. In an embodiment of the disclosure, the processor may be configured to generate an output video based on the scaled image frame.

In an embodiment of the disclosure, the processor may be configured to generate a model output data distribution for the reconstructed image frame. In an embodiment of the disclosure, the processor may be configured to perform a pixel mapping for the scaling operation based on the offset information and the model output data distribution. In an embodiment of the disclosure, the processor may be configured to perform the scaling operation on the reconstructed image frame based on the pixel mapping to generate the scaled image frame.

In an embodiment of the disclosure, the scaling operation may include at least one of an addition operation, a multiplication operation, a divisional operation, or an exponential operation.

According to an embodiment of the disclosure, one or more operations described as being performed on an image frame may be performed on a video that may include the image frame, and similarly, one or more operations described as being performed on a video may be performed on an image frame included in the video.

The various actions, acts, blocks, steps, operations, or the like in the flow diagrams may be performed in the order presented, in a different order, or simultaneously. Further, in one or more embodiments of the disclosure, some of the actions, acts, blocks, steps, or the like may be omitted, added, modified, skipped, or the like without departing from the scope of the present disclosure.

Unless otherwise defined, all technical and scientific terms used herein have the same meaning as commonly understood by one ordinary skilled in the art to which the present disclosure belongs. The system, methods, and examples provided herein may be illustrative only and may not be intended to be limiting.

While specific language has been used to describe the present subject matter, any limitations arising on account thereto, are not intended. As would be apparent to a person skilled in the art, various working modifications may be made to the method to implement the present disclosure as taught herein. The drawings and the forgoing description give examples of embodiments. Those skilled in the art may appreciate that one or more of the described elements may well be combined into a single functional element. Alternatively, certain elements may be split into multiple functional elements. Elements from one embodiment may be added to another embodiment.

The embodiments disclosed herein may be implemented using at least one hardware device and performing network management functions to control the elements.

The foregoing description of the specific embodiments may so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art may recognize that the embodiments herein may be practiced with modification within the scope of the embodiments as described herein.

What is claimed is:

1. A method performed by an electronic device, for artificial intelligence (AI)-based encoding of media, the method comprising:
compressing an input image frame associated with an input video;
generating, by an AI-based in-loop filter, a reconstructed image frame corresponding to the input image frame;
determining an offset value based on the input image frame and the reconstructed image frame; and
encoding the reconstructed image frame based on the offset value.

2. The method of claim 1, wherein the determining of the offset value comprises:
generating a model output data distribution of the reconstructed image frame;
generating a ground-truth data distribution of the input image frame; and
determining the offset value based on the model output data distribution and the ground-truth data distribution.

3. The method of claim 2, wherein the generating of the model output data distribution comprises:
identifying a number of fragments of the reconstructed image frame, based on a user input;
analyzing, using one or more distribution mechanisms, content variation within the reconstructed image frame;
fragmenting the reconstructed image frame based on the number of fragments and an analysis result of the content variation to generate an optimal fragmented image frame;
performing a pixel binning operation, using one or more statistical mechanisms, on one or more fragments of the optimal fragmented image frame, the optimal fragmented image frame comprising a group of pixels with a similar characteristic; and
generating, based on the pixel binning operation, a set of one or more first representative data points of the optimal fragmented image frame.

4. The method of claim 3, wherein the generating of the ground-truth data distribution comprises:
identifying a number of fragments for the input image frame, based on a user input;
analyzing, using one or more distribution mechanisms, content variation within the input image frame;
fragmenting the input image frame based on the number of fragments and an analysis result of the content variation to generate an optimal fragmented input image frame;
performing a pixel binning operation, using one or more statistical mechanisms, on one or more fragments of the optimal fragmented input image frame, the optimal fragmented input image frame comprising a group of pixels with a similar characteristic; and
generating, based on the pixel binning operation, a set of one or more second representative data points of the optimal fragmented input image frame.

5. The method of claim 4, wherein the determining of the offset value based on the model output data distribution and the ground-truth data distribution comprises:
determining a data distribution dissimilarity metric between the set of one or more first representative data points and the set of one or more second representative data points; and
determining the offset value based on the data distribution dissimilarity metric.

6. The method of claim 2, wherein the determining of the offset value based on the model output data distribution and the ground-truth data distribution comprises:
determining, in a form of a per-fragment offset, a pixel mapping using the model output data distribution, the ground-truth data distribution, and a mapping extent.

7. The method of claim 6, further comprising:
determining the mapping extent based on a number of fragments and a codec rate distortion (RD) cost, the mapping extent indicating whether to apply an offset scaling to a fragment on a basis of an RD cost.

8. The method of claim 1, wherein the encoding of the reconstructed image frame comprises:
performing a scaling operation on the reconstructed image frame based on the offset value to generate a scaled image frame, the scaling operation comprising at least one of an addition operation, a multiplication operation, a division operation, or an exponential operation; and
encoding the scaled image frame.

9. The method of claim 1, wherein generating of the reconstructed image frame comprises:
generating, by using one or more neural network (NN) models of the AI-based in-loop filter, the reconstructed image frame.

10. The method of claim 1, further comprising:
sending, to a decoder, bitstream information associated with the reconstructed image frame, the bitstream information comprising the offset value.

11. The method of claim 1, wherein the determining of the offset value comprises:
computing the offset value at a per-fragment granularity.

12. A method performed by an electronic device, for artificial intelligence (AI)-based decoding of media, the method comprising:
receiving, from an encoder, bitstream information comprising offset information;
generating, by an AI-based in-loop filter, a reconstructed image frame based on the bitstream information;
performing a scaling operation on the reconstructed image frame based on the offset information to generate a scaled image frame; and
generating an output video based on the scaled image frame.

13. The method of claim 12, wherein the performing of the scaling operation comprises:
generating a model output data distribution of the reconstructed image frame;
determining a pixel mapping based on the offset information and the model output data distribution; and
performing the scaling operation on the reconstructed image frame based on the pixel mapping to generate the scaled image frame.

14. The method of claim 12, wherein the scaling operation comprises at least one of an addition operation, a multiplication operation, a division operation, or an exponential operation.

15. A system for artificial intelligence (AI)-based encoding of media, wherein the system comprises:
memory storing instructions; and
one or more processors communicatively coupled to the memory, the one or more processors being configured to execute the instructions to:
compress an input image frame associated with an input video;
generate, by an AI-based in-loop filter, a reconstructed image frame corresponding to the input image frame;
determine an offset value based on the input image frame and the reconstructed image frame; and
encode the reconstructed image frame based on the offset value.

16. The system of claim 15, wherein the one or more processors are further configured to execute the instructions to:
generate a model output data distribution of the reconstructed image frame;
generate a ground-truth data distribution of the input image frame; and
determine the offset value based on the model output data distribution and the ground-truth data distribution.

17. The system of claim 16, wherein the one or more processors are further configured to execute the instructions to:
identify a number of fragments of the reconstructed image frame, based on a user input;
analyze, using one or more distribution mechanisms, content variation within the reconstructed image frame;
fragment the reconstructed image frame based on the number of fragments and an analysis result of the content variation to generate an optimal fragmented image frame;
perform a pixel binning operation, using one or more statistical mechanisms, on one or more fragments of the optimal fragmented image frame, the optimal fragmented image frame comprising a group of pixels with a similar characteristic; and
generate, based on the pixel binning operation, a set of one or more first representative data points of the optimal fragmented image frame.

18. The system of claim 17, wherein the one or more processors are further configured to execute the instructions to:
identify a number of fragments for the input image frame, based on a user input;
analyze, using one or more distribution mechanisms, content variation within the input image frame;
fragment the input image frame based on the number of fragments and an analysis result of the content variation to generate an optimal fragmented input image frame;
perform a pixel binning operation, using one or more statistical mechanisms, on one or more fragments of the optimal fragmented input image frame, the optimal fragmented input image frame comprising a group of pixels with a similar characteristic; and
generate, based on the pixel binning operation, a set of one or more second representative data points of the optimal fragmented input image frame.

19. The system of claim 18, wherein the one or more processors are further configured to execute the instructions to:
determine a data distribution dissimilarity metric between the set of one or more first representative data points and the set of one or more second representative data points; and
determine the offset value based on the data distribution dissimilarity metric.

20. The system of claim 16, wherein the one or more processors are further configured to execute the instructions to:
determine, in a form of a per-fragment offset, a pixel mapping using the model output data distribution, the ground-truth data distribution, and a mapping extent.
